(19) United States
(12) Patent Application Publication
(10) Pub. No.: US 2010/0205763 A1
(43) Pub. Date: Aug. 19, 2010

(54) Universal Adaptors for Connecting Wiper Blades to Wiper Arms

(75) Inventor: Yuan-Chin Ku, Hsin-Chuang City (TW)

Correspondence Address: Brinks Hofer Gilson & Lione/Ann Arbor, 524 South Main Street, Suite 200, Ann Arbor, MI, 48104, US

(73) Assignee: Chin Pech Co., Ltd., Hsin-Chuang City (TW)

(21) Appl. No.: 12/708,197

(22) Filed: Feb. 18, 2010

Related U.S. Application Data
(60) Provisional application No. 61/153,334, filed on Feb. 18, 2009.

(51) Int. Cl. B60S 1/40

(52) U.S. Cl. 15/250.32

(57) ABSTRACT

An adaptor assembly is provided to connect a wiper blade to a plurality of wipe arms. The adaptor assembly includes a proximal member, a distal member, and a pair of side walls disposed between the proximal member and the distal member. A plurality of seats are provided adjacent to the side walls for supporting the plurality of wiper arms. At least one of the plurality of wiper arms defines a U-shaped housing.

### CROSS REFERENCE TO RELATED APPLICATIONS

This application claims priority of U.S. Provisional Application No. 61/153,334, filed on Feb. 18, 2009 and entitled “Universal Adaptors for Connecting Wiper Blades to Wiper Arms,” the disclosure of which is incorporated herein by reference in its entirety.

### FIELD

The present disclosure relates to wiper blade assemblies, and more particularly to adaptor assemblies for connecting wiper blades to wiper arms.

### BACKGROUND

Different auto makers generally provide wiper arms of different configurations on their vehicles. For example, the wiper arms may have connecting ends that are configured to form a pin, a plate, a bayonet, a hook, U-shaped housings of different sizes, U-shaped housings with distinct locking features, or a combination of an L-shaped leg and a circular pin.

Wiper blades are consumables and are replaceably mounted to the wiper arms by adaptors. Generally, the adaptors are configured to fit only a specific type of wiper arms and include locking features to engage corresponding locking features on the wiper arms. Due to a wide variety of wiper arms on the market, the types of the adaptors adapted for these wiper arms are abundant. Therefore, automotive repair and service shops generally need to have a wide variety of adaptors in stock to better serve their customers, thereby increasing operating costs.

### SUMMARY

In one form, an adaptor assembly for connecting a wiper blade to a plurality of wipe arms includes a proximal member, a distal member, and a pair of side walls disposed between the proximal member and the distal member. A plurality of seats are provided adjacent to the side walls. Each seat is configured differently from the other of the plurality of seats to support one of the plurality of wiper arms having different configurations. At least one of the plurality of wiper arms defines a U-shaped housing.

In another form, an adaptor for connecting a wiper blade to a plurality of wiper arms includes a proximal member, a distal member, and a pair of side walls disposed between the proximal member and the distal member and defining a cavity. The proximal member defines a cutout. The distal member includes a base portion and a pair of legs. The base portion includes an upper surface and a pair of recessed portions recessed from the upper surface. A part of the base portion extends into the cavity. A pair of first longitudinal members are disposed laterally from the side walls. A pair of second longitudinal members are disposed laterally from the first longitudinal members and laterally from the first longitudinal members. A transverse member is disposed in the cavity. A pair of lateral flanges are disposed adjacent to the proximal member and aligned with the pair of recessed portions. The pair of the first longitudinal members define a first seat for supporting a first wiper arm, a third wiper arm, and a fourth wiper arm. The pair of the second longitudinal members define a second seat for supporting a second wiper arm. The transverse member and the upper surface of the base portion of the distal member define a third seat for supporting a fifth wiper arm. The pair of the lateral flanges and the recessed portions of the base portion of the distal member define a fourth seat for supporting a sixth wiper arm. The side walls between the proximal member and the distal member define a fifth seat for friction-fit with a seventh wiper arm.

In still another form, an adaptor assembly for mounting a wiper blade to a plurality of wiper arms includes a proximal member, a pair of side walls, and at least one of a pair of first longitudinal members, a pair of second longitudinal members, a transverse member, and a base portion. The pair of side walls include proximal ends connected to the proximal member and distal ends opposite to the proximal ends. The side walls define a cavity. The pair of first longitudinal members are disposed laterally from the side walls for supporting a first wiper arm. The pair of second longitudinal members are disposed laterally from the side walls and the first longitudinal members for supporting a second wiper arm. The transverse member is disposed in the cavity for supporting a third wiper arm. The base portion is disposed at the distal ends of the side walls for supporting a fourth wiper arm.

In still another form, an adaptor assembly for mounting a wiper blade to a plurality of wiper arms includes a proximal member, a distal member defining a pair of securing features, a pair of side walls disposed between the proximal member and the distal member, and a first seat provided at the side walls and adapted to support a first wiper arm and a second wiper arm. The first wiper arm includes a first U-shaped housing and a pair of first securing tabs. The second wiper arm includes a second U-shaped housing and a pair of second securing tabs having a configuration different from the first securing tabs. The securing features are adapted to engage the first securing tabs and the second securing tabs.

In still another form, a wiper blade and wiper arm assembly includes a wipe blade, and adaptor assembly, a plurality of wiper arms. The adaptor assembly is mounted to the wiper blade and includes a plurality of seats. The plurality of wiper arms includes at least one wiper arm defining a U-shaped housing. The plurality of seats are adapted to support the plurality of wiper arms thereon.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a partial exploded view of a wiper blade assembly adapted for a plurality of wiper arms according to the teachings of the present disclosure;

FIG. 2 is a perspective view of an adaptor assembly according to the teachings of the present disclosure;

FIG. 3 is an exploded view of an adaptor assembly according to the teachings of the present disclosure;

FIG. 4 is a cross-sectional view of an adapting member of an adaptor assembly, taken along line A-A of FIG. 3;

FIGS. 5, 6, and 7 are perspective views of an adapting member of an adaptor assembly according to the present disclosure;

FIG. 8 is a cross-sectional view of an adapting member of an adaptor assembly, taken along line B-B of FIG. 6;

FIG. 9 is a perspective view of a cover of an adaptor assembly according to the present disclosure;

FIG. 10 is a front view of an adaptor assembly, wherein the cover is in a closed position;

FIG. 11 a front view of an adaptor assembly, wherein the cover is in an open position;

FIG. 12 is a perspective view of a first wiper arm, which can be mounted to an adaptor assembly according to the present disclosure;

FIG. 13 is a front view of the first wiper arm of FIG. 12;

FIG. 14 is a perspective view of a wiper arm assembly that includes a first wiper arm and an adaptor assembly, illustrating steps of assembling a first wiper arm to the adaptor assembly;

FIG. 15 is a perspective view of a wiper arm assembly that includes a first wiper arm and an adaptor assembly;

FIG. 16 is a front view of a wiper arm assembly that includes a first wiper arm and an adaptor assembly;

FIG. 17 is a top view of a wiper arm assembly that includes a first wiper arm and an adaptor assembly, wherein the cover is removed for clarity;

FIG. 18 is a cross-sectional view of a wiper arm assembly, taken along line C-C of FIG. 15;

FIGS. 19 and 20 are perspective views of a second wiper arm, which can be mounted to an adaptor assembly according to the present disclosure;

FIG. 21 is a perspective view of a wiper arm assembly that includes a second wiper arm and an adaptor assembly, illustrating steps of assembling a second wiper arm to the adaptor assembly;

FIGS. 22 and 23 are perspective views of a wiper arm assembly that includes a second wiper arm and an adaptor assembly;

FIG. 24 is a front view of a wiper arm assembly that includes a second wiper arm and an adaptor assembly;

FIG. 25 is a bottom view of a wiper arm assembly that includes a second wiper arm and an adaptor assembly;

FIG. 26 is a back view of a wiper arm assembly that includes a second wiper arm and an adaptor assembly;

FIGS. 27 and 28 are perspective views of a third wiper arm, which can be mounted to an adaptor assembly according to the present disclosure;

FIG. 29 is a front view of the third wiper arm of FIG. 27;

FIG. 30 is a perspective view of a wiper arm assembly that includes an adaptor assembly and a third wiper arm, illustrating steps of assembling the third wiper arm to the adaptor assembly;

FIG. 31 is a perspective view of a wiper arm assembly that includes a third wiper arm and an adaptor assembly;

FIG. 32 is a top view of a wiper arm assembly that includes a third wiper arm and an adaptor assembly;

FIG. 33 is a front view of a wiper arm assembly that includes a third wiper arm and adaptor assembly;

FIG. 34 is a cross-sectional view of a wiper arm assembly, taken along line D-D of FIG. 32;

FIG. 35 is a perspective view of a fourth wiper arm, which can be mounted to an adaptor assembly according to the present disclosure;

FIG. 36 is a perspective view of a wiper arm assembly that includes a fourth wiper arm, an intermediate member, and an adaptor assembly according to the present disclosure;

FIG. 37 is an exploded view of a wiper arm assembly that includes a fourth wiper arm, an intermediate member, and an adaptor assembly according to the present disclosure;

FIGS. 38 and 39 are perspective views of an intermediate member for connecting a fourth wiper arm to an adaptor assembly;

FIG. 40 is a top view of an intermediate member for connecting a fourth wiper arm to an adaptor assembly;

FIG. 41 is a perspective view of a wiper arm assembly that includes an adaptor assembly and a fourth wiper arm, illustrating steps of assembling a fourth wiper arm to the adaptor assembly;

FIG. 42 is a top view of an intermediate member mounted to an adaptor assembly;

FIG. 43 is a cross-sectional view of a wiper arm assembly that includes a fourth wiper arm, an intermediate member, and an adaptor assembly, taken along line E-E of 36;

FIG. 44 is a front view of an intermediate member mounted to an adaptor assembly;

FIG. 45 is a perspective view of a fifth wiper arm, which can be mounted to an adaptor assembly according to the present disclosure;

FIG. 46 is a perspective view of a wiper arm assembly that includes a fifth wiper arm and an adaptor assembly, illustrating steps of assembling a fifth wiper arm to the adaptor assembly;

FIG. 47 is a perspective view of a wiper arm assembly that includes a fifth wiper arm and an adaptor assembly;

FIG. 48 is a top view of a fifth wiper arm mounted to an adaptor assembly, wherein the cover is removed for clarity;

FIG. 49 is a cross-sectional view of a wiper arm assembly that includes a fifth wiper arm and an adaptor assembly, taken along line F-F of FIG. 48;

FIG. 50 is a cross-sectional view of a wiper arm assembly that includes a fifth wiper arm and an adaptor assembly, taken along line G-G of FIG. 48;

FIG. 51 is a perspective view of a sixth wiper arm, which can be mounted to an adaptor assembly according to the present disclosure;

FIG. 52 is an exploded view of a wiper arm assembly that includes a sixth wiper arm, a securing housing, and an adaptor assembly according to the present disclosure;

FIG. 53 is a perspective view of a securing housing for securing a sixth wiper arm to an adaptor assembly according to the present disclosure;

FIG. 54 is a perspective view of a wiper arm assembly that includes an adaptor assembly and a sixth wiper arm, illustrating steps of assembling the sixth wiper arm to the adaptor assembly;

FIG. 55 is a perspective view of a wiper arm assembly that includes a sixth wiper arm and an adaptor assembly;

FIG. 56 is a perspective view of a wiper arm assembly of FIG. 55, wherein the securing housing is removed for clarity;

FIG. 57 is a cross-sectional view of a wiper arm assembly that includes a sixth wiper arm, a securing housing, and an adaptor assembly, taken along line H-H of FIG. 55;

FIG. 58 is a partial perspective and cross-sectional view of a wiper arm assembly, taken along line I-I of FIG. 56;

FIG. 59 is another partial perspective, cross-sectional view of a wiper arm assembly, taken along line J-J of FIG. 58;

FIG. 60 is a perspective view of a seventh wiper arm, which can be mounted to an adaptor assembly according to the present disclosure;

FIG. 61 is a top view of a seventh wiper arm, which can be mounted to an adaptor assembly according to the present disclosure;

FIG. 62 is a view of a wiper arm assembly that includes a seventh wiper arm and an adaptor assembly, illustrating the steps of assembling a sixth wiper arm to the adaptor assembly;

FIG. 63 is a perspective view of a wiper arm assembly that includes a seventh wiper arm and an adaptor assembly according to the present disclosure;

FIG. 64 is a front view of a wiper arm assembly that includes a seven wiper arm and an adaptor assembly according to the present disclosure; and

FIG. 65 is a cross-sectional view of a wiper arm assembly that includes a seventh wiper arm and an adaptor assembly according to the present disclosure.

### DETAILED DESCRIPTION

The following description of the embodiments is merely exemplary in nature and is in no way intended to limit the disclosure, its application, or use.

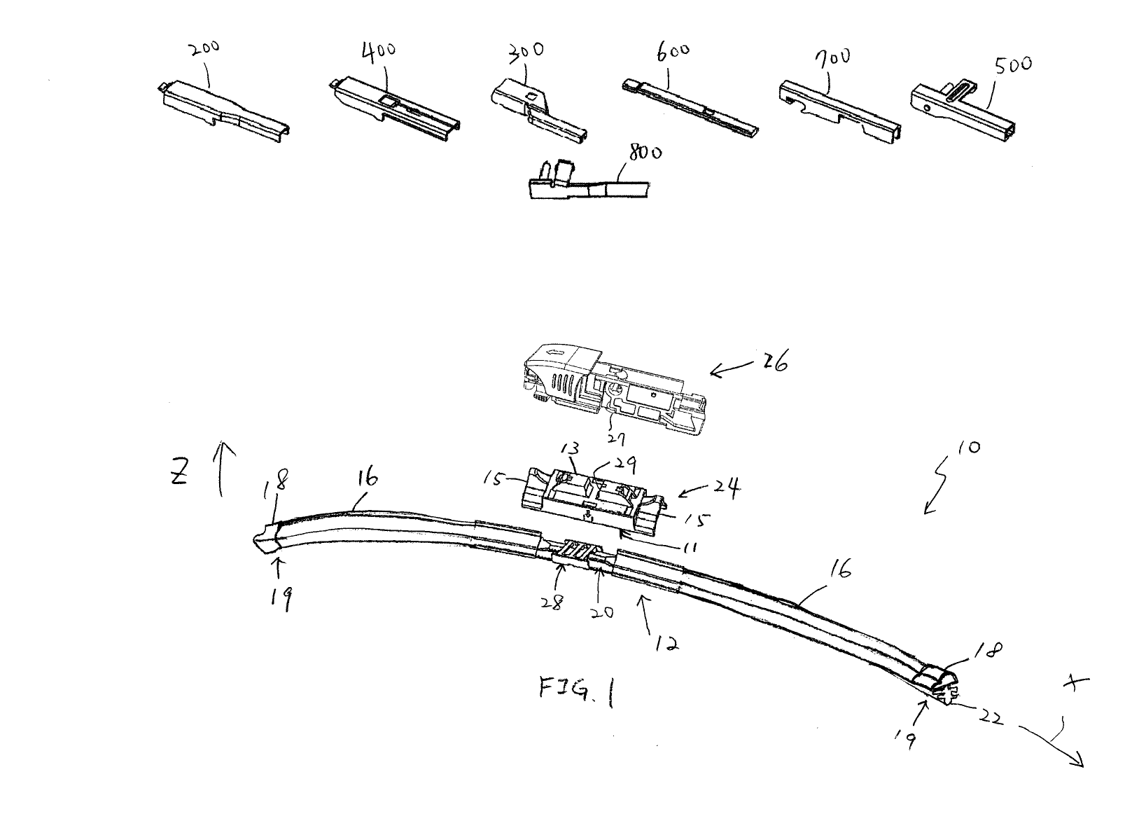

Referring to FIG. 1, a wiper blade assembly 10 includes a wiper blade 12, an adaptor assembly 26, and a base member 24. The wiper blade 12 includes a spring support element 20 and a rubber wiper strip 22 attached to the spring support element 20 by inserting a portion of the rubber wiper strip 22 through an elongated slot (not shown) of the spring support element 20. The spring support element 20 is formed as one piece. Attachment of the rubber wiper strip 22 to the one-piece spring support element 20 has been disclosed in a co-pending application Ser. No. 11/498,964 and titled “Wiper Blade Support Structure,” the disclosure of which is incorporated herein by reference in its entirety.

Optionally, the wiper blade assembly 10 may include a pair of spoilers 16 provided on both sides of the adaptor assembly 26 for reducing wind resistance and a pair of end caps 18 at longitudinal ends 19 of the wiper blade assembly 10 for securing the spoilers 16 on the spring support element 20.

The adaptor assembly 26 configured according to the present disclosure is pivotably mounted to the base member 24, which, in turn, is mounted to the wiper blade 12 through a bridge base 28. It is understood and appreciated that the base member 24 and the bridge base 28 may be interpreted to be a part of the adaptor assembly 26 without departing from the scope of the present disclosure. The bridge base 28 is shown to be secured to the wiper blade 12 and may be considered a part of the wiper blade 12. The bridge base 28 may be mounted to the wiper blade 12 by any means known in the art, such as by welding, clamping, screw, among others. The base member 24 may be removably mounted on the bridge base 28 in a snap-fit relationship. Mounting of the base member 24 to the bridge base 28 has been disclosed in a co-pending application Ser. No. 12/250,073, titled “Adaptor Assemblies for Connecting Wiper Blades to Wiper Arms,” the disclosure of which is incorporated by reference in its entirety.

The adaptor assembly 26 may be removably and pivotably mounted on the base member 24. The adaptor assembly 26 may include a pin 27 to be inserted into a corresponding groove 29 in the base member 24. The base member 24 includes a base 11 in a substantially U-shaped configuration, and an extension 13 extending upwardly from the base 11. The groove 29 is formed in the extension 13. The base member 24 can optionally be provided with a pair of spoiler receiving portions 15 at both ends of the base 11 for covering and securing a portion of the spoilers 16.

Mounting of the adaptor assembly 26 to the base member 26 may be achieved by any method other than that shown in the drawings. For example, the base member 24 may include a pin extending from the base 11, whereas the adaptor assembly 26 may define a groove for receiving the pin therein. It is also understood and appreciated that the adaptor assembly 26 may be mounted directly to the wiper blade 12 without using the base member 24. For example, the adaptor assembly 26 may define one of a pin and a groove, and the wiper blade 12 may define the other one of the pin and the groove for engaging the adaptor assembly 26. The adaptor assembly 26 of the present disclosure can adapt for seven types of wiper arms 200, 300, 400, 500, 600, 700, and 800.

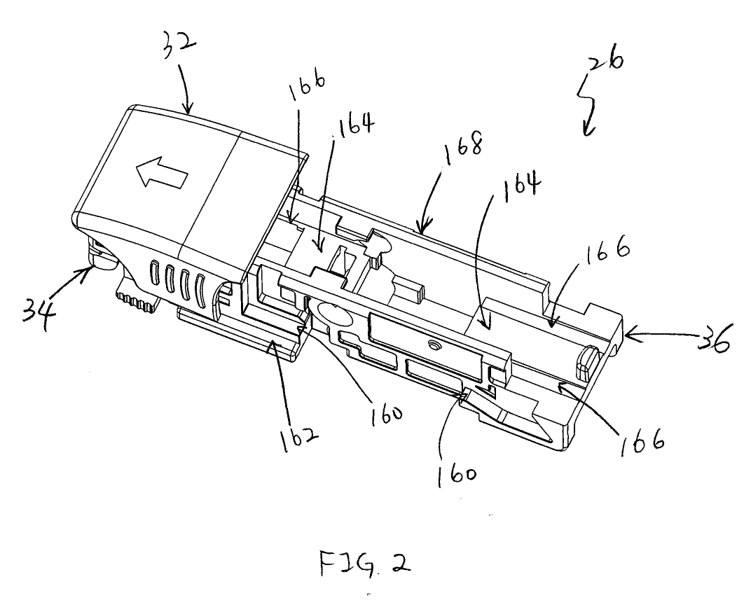

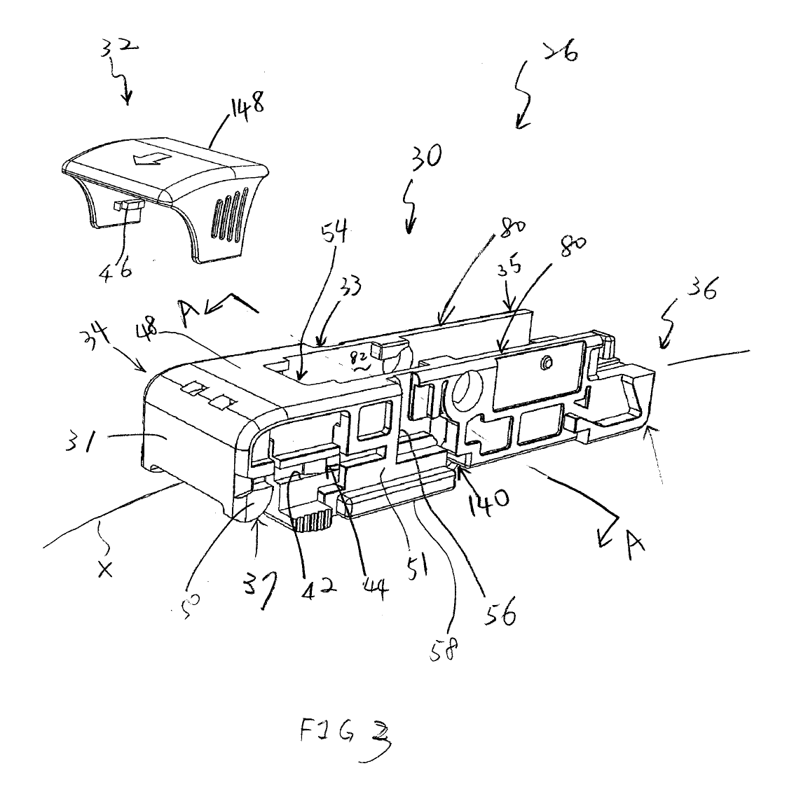

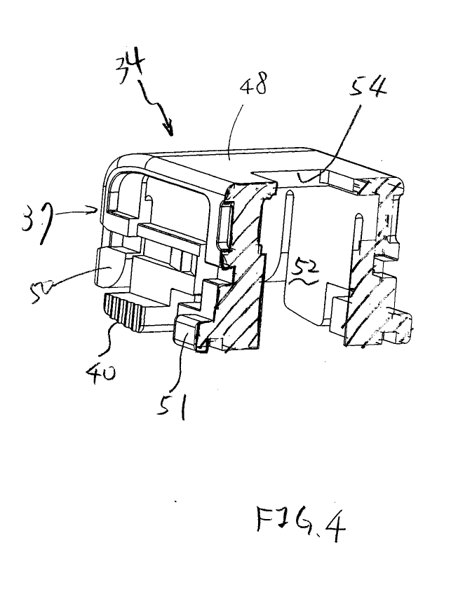

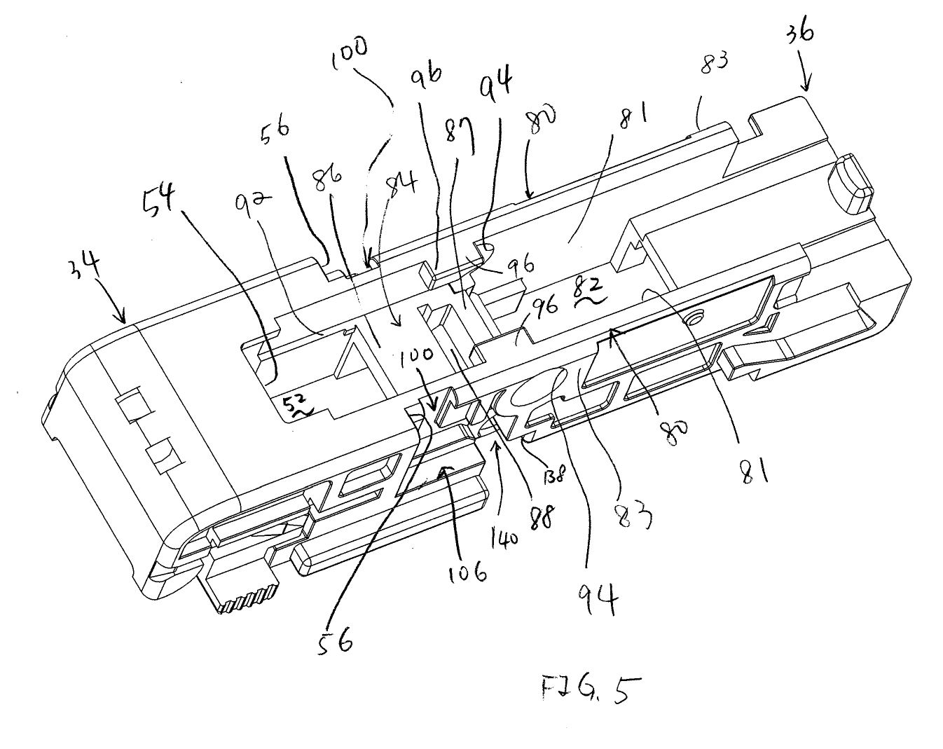

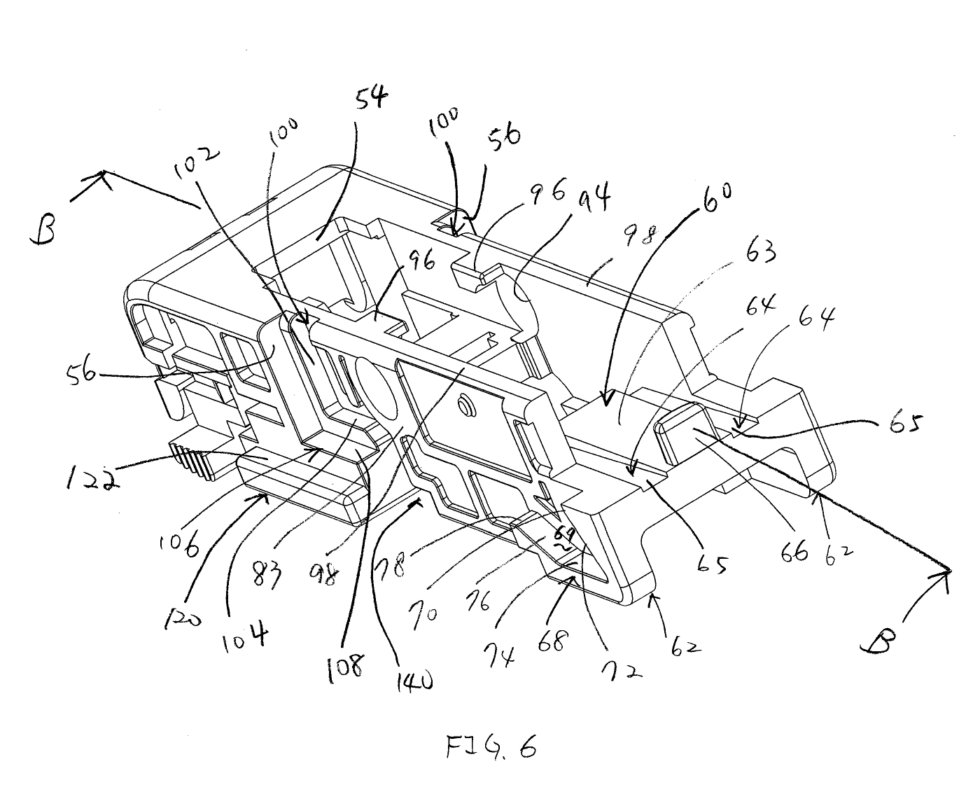

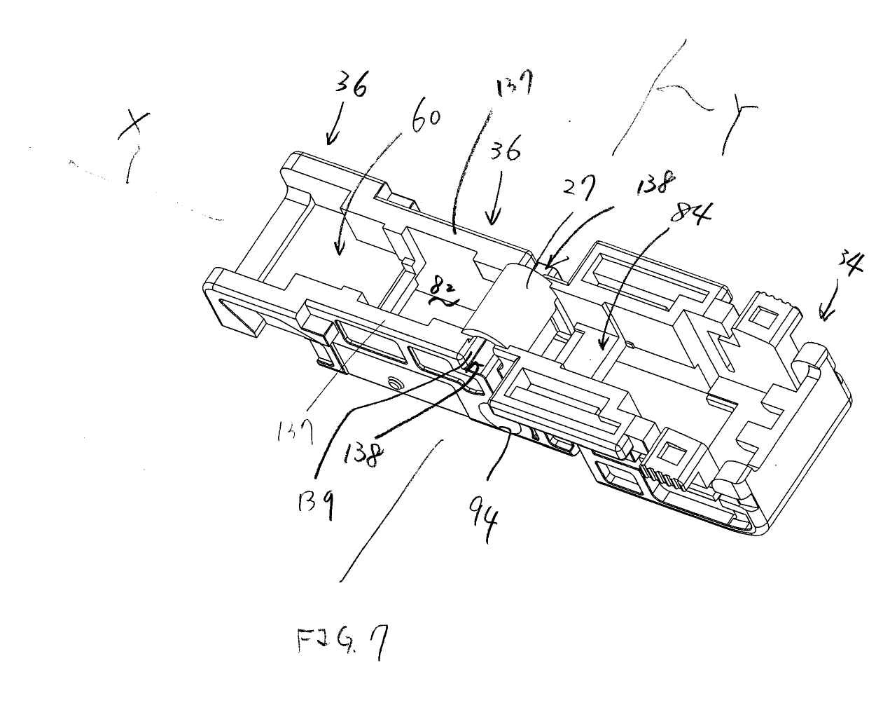

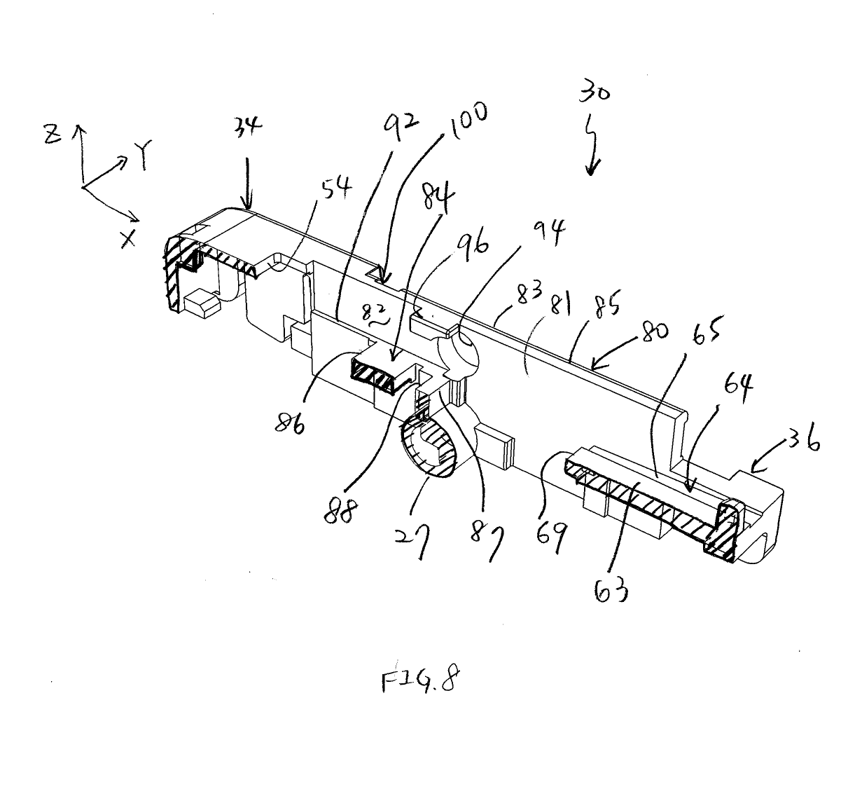

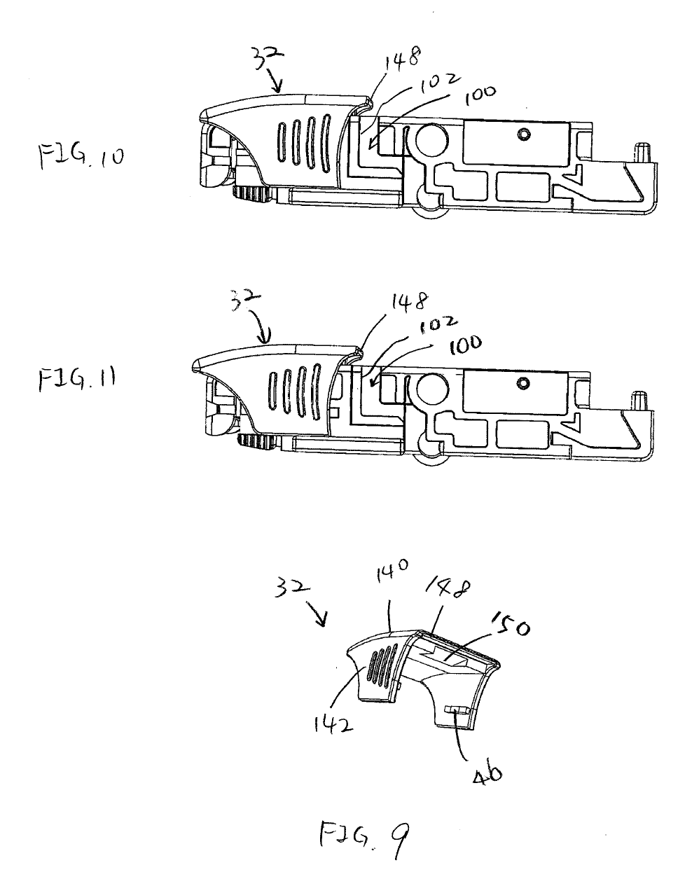

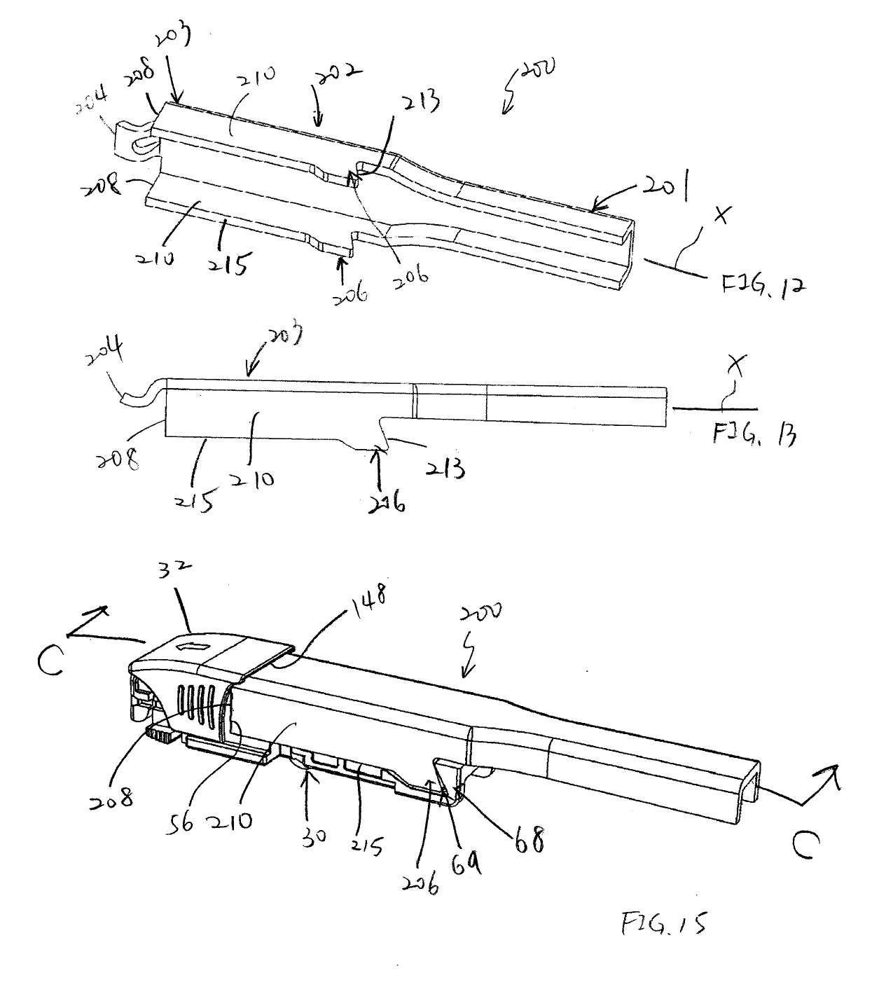

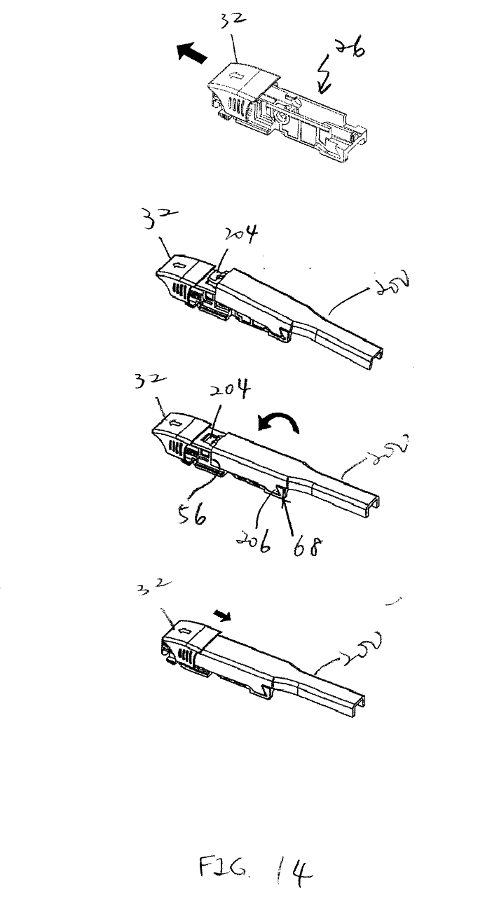

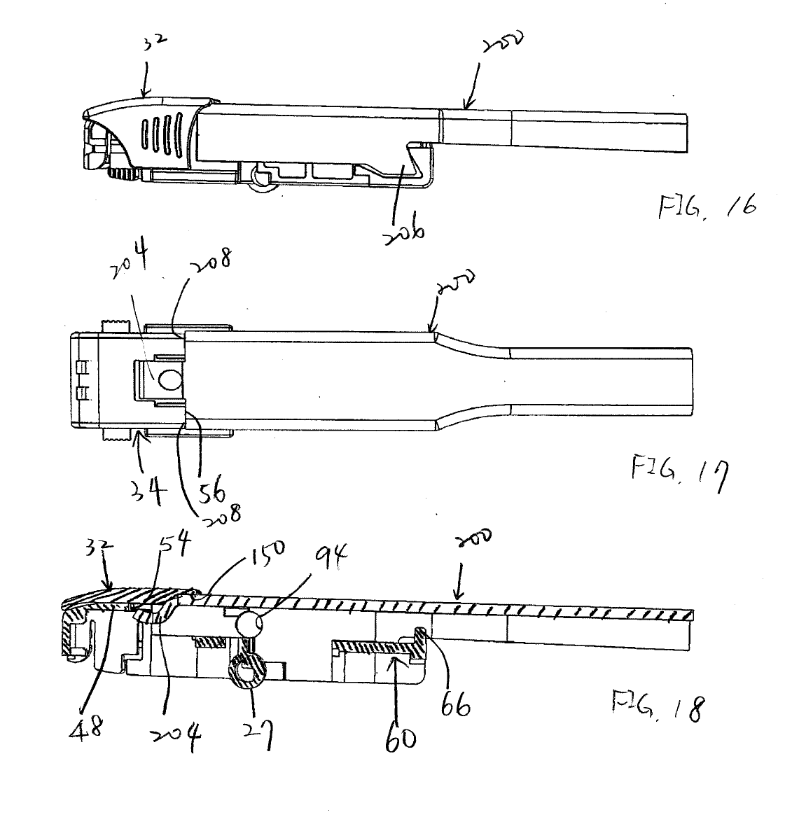

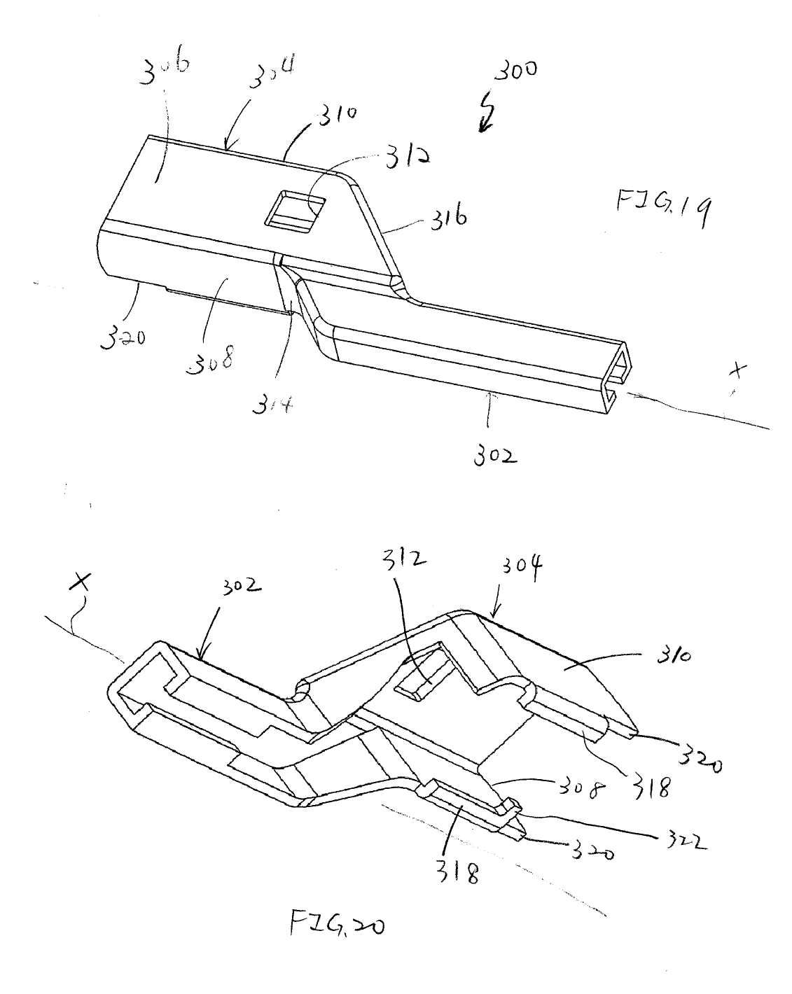

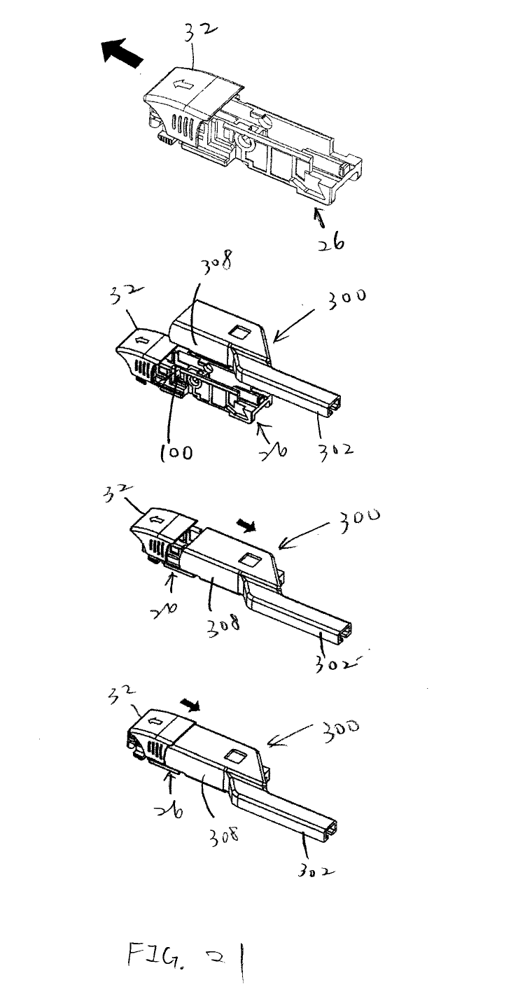

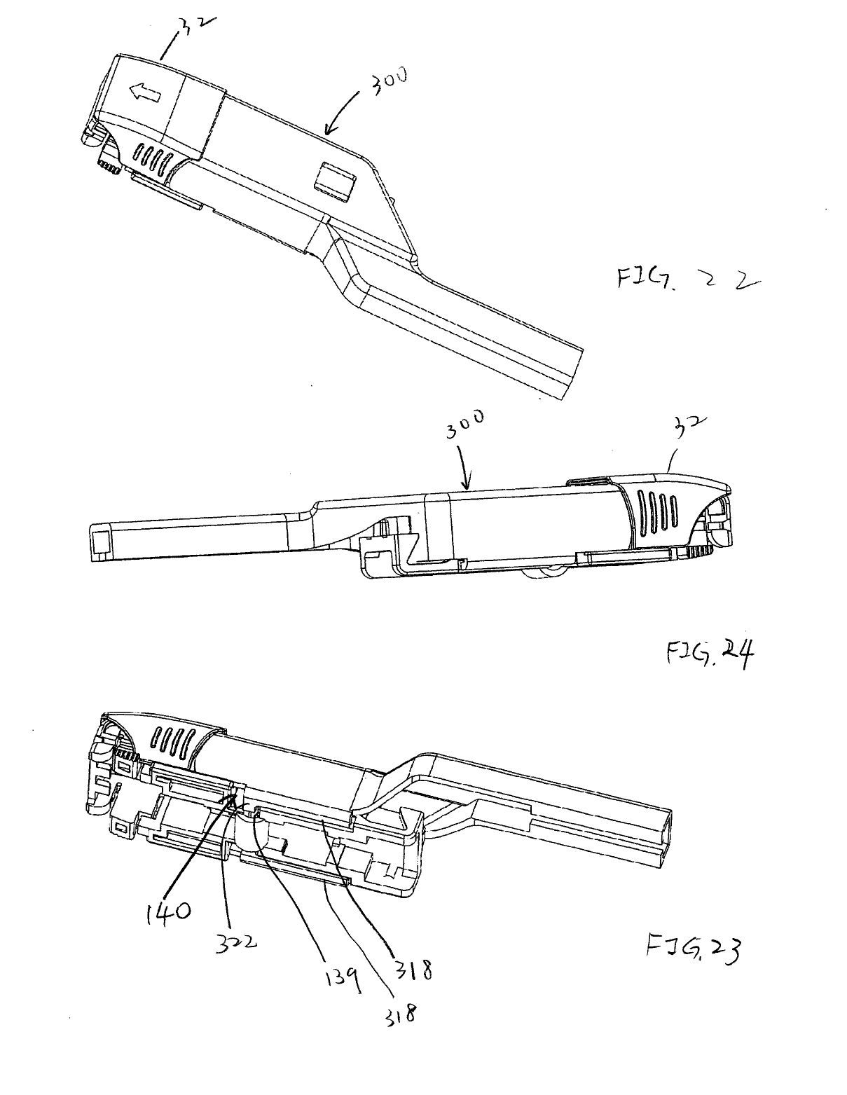

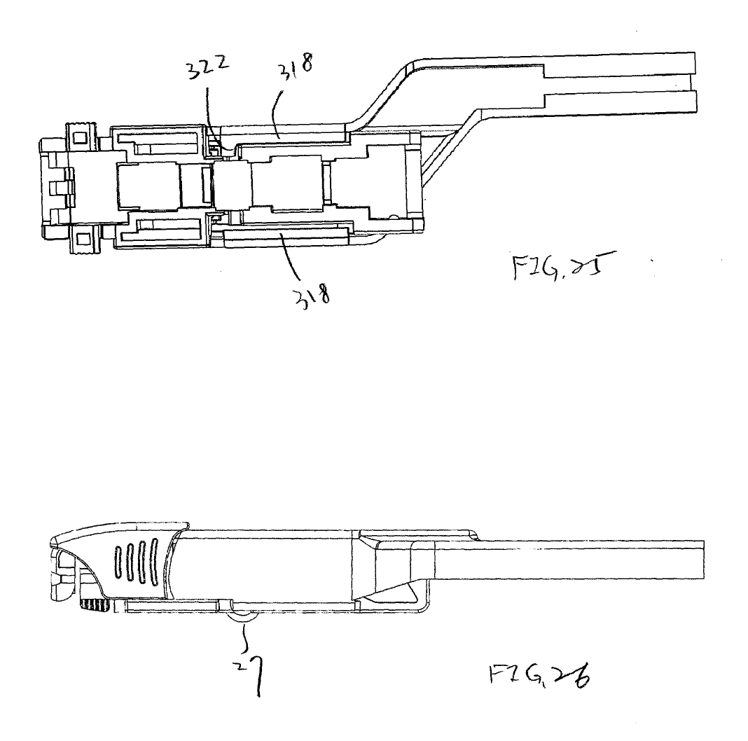

Referring to FIG. 2, the adaptor assembly 26 includes a plurality of seats 160, 162, 164, 166 and 168 adapted for a plurality of wiper arms 200, 300, 400, 500, 600, 700, 800. Any one of the seats 160, 162, 164, 166, and 168 may be adapted to support more than one type of wiper arms. For example, the seat 160 can be used to support the first wiper arm 200 and the third wiper 400. The structures of the plurality of seats 160, 162, 164, 166, and 168 will be described in more detail later.

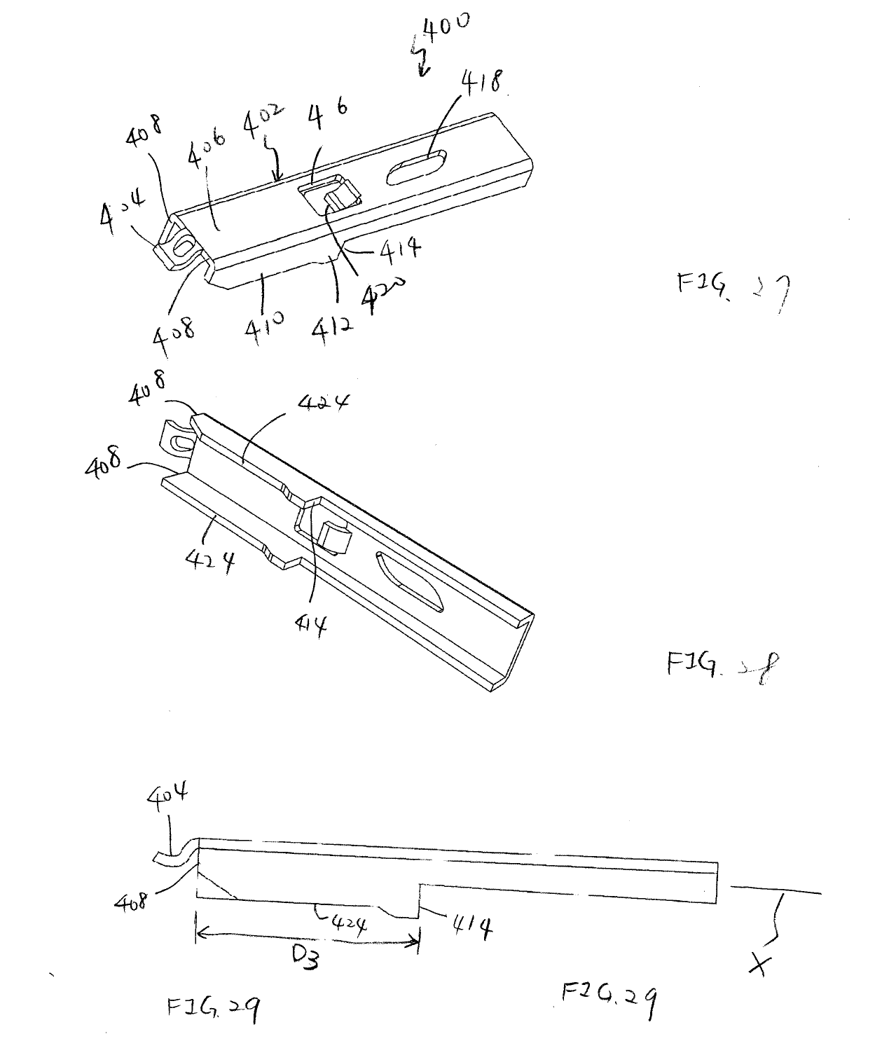

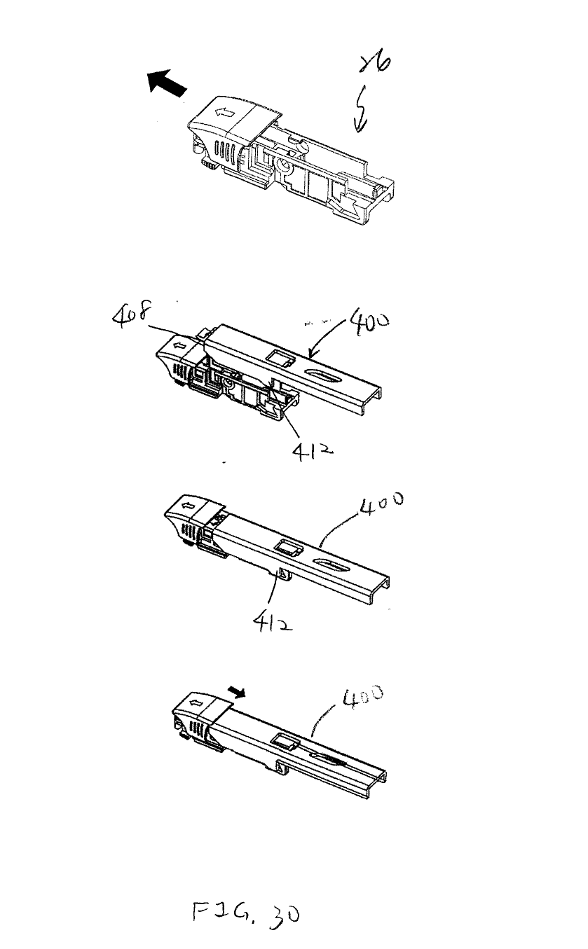

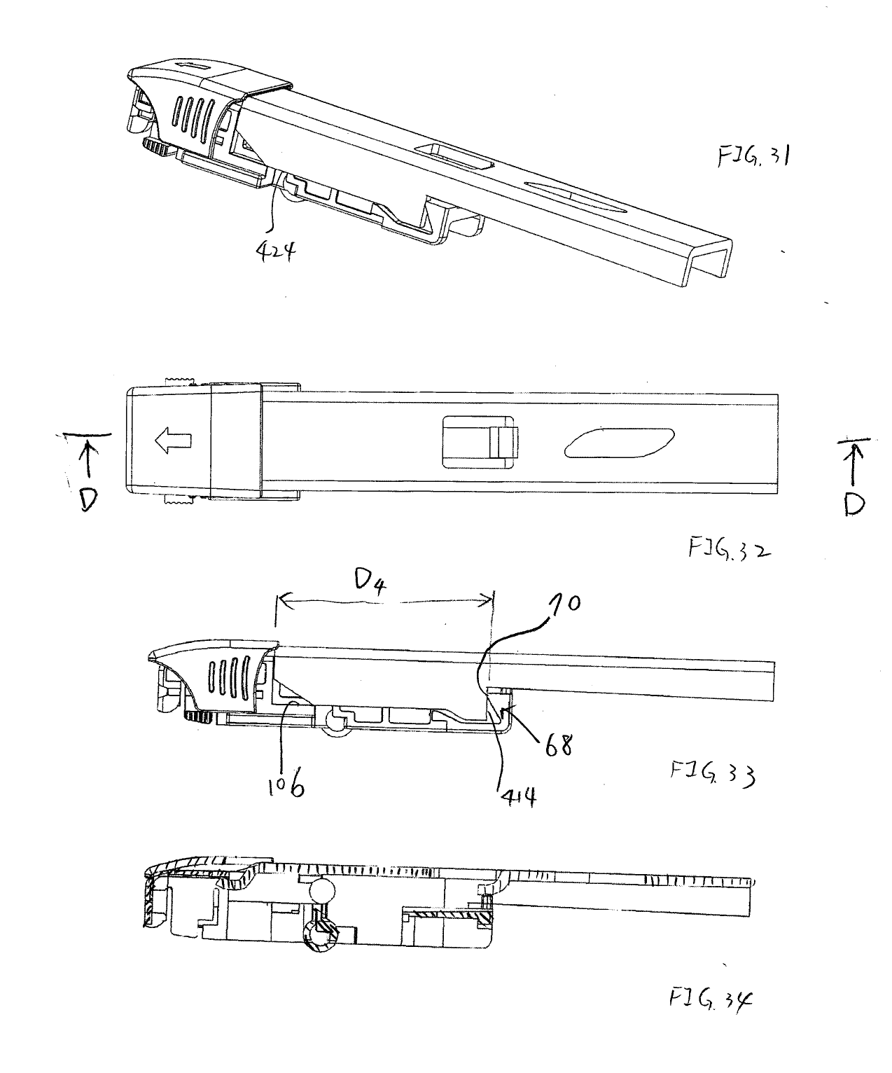

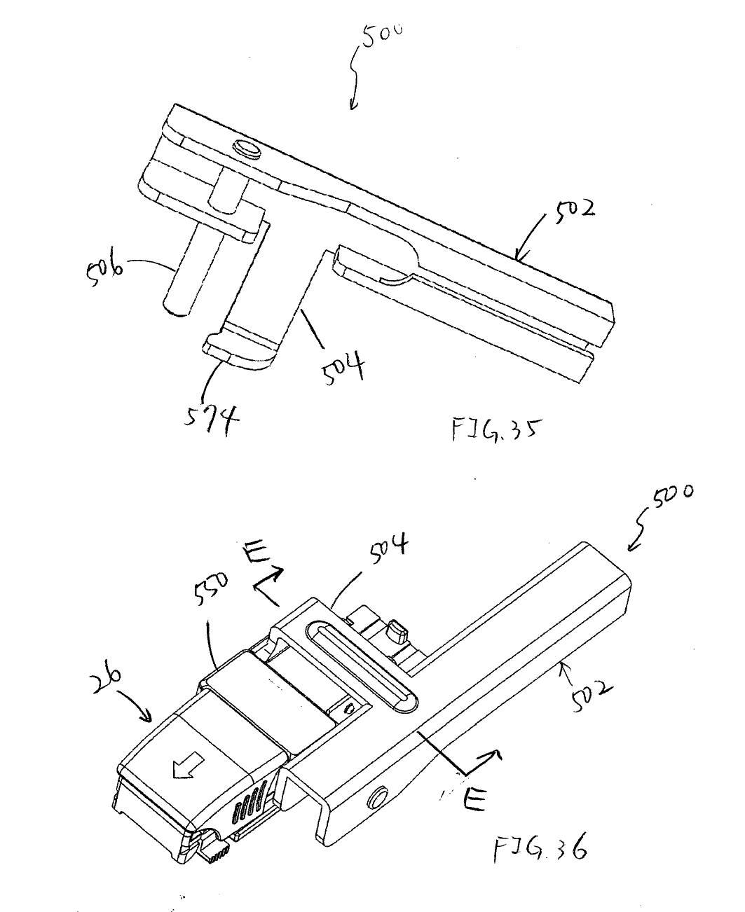

Referring to FIG. 3, the adaptor assembly 26 includes an adapting member 30, and a cover 32. The adapting member 30 includes a proximal (or front) member 34, a distal (or rear) member 36, and a pair of side walls 80 disposed therebetween. The cover 32 is moveably mounted on the proximal member 34 and may be considered a part of the proximal member 34. The side walls 80 each include a proximal end 33 and a distal end 35. The proximal member 34 is connected to the proximal ends 33 of the side walls 80. The distal member 36 is connected to the distal ends 35 of the side walls 80. An elongated cavity 82 is defined between the pair of side walls 80 and the proximal member 34 and the distal member 36.

The word “distal” or “distally” as used in the present application refers to an end close to a driving end of the wiper arm, whereas the word “proximal” or “proximally” refers to a free end of the wiper arm opposite to the driving end. The cover 32 is slidingly mounted to the proximal member 34 along a longitudinal direction X. The longitudinal direction X is the direction where the wiper blade 12 and the wiper arm extend.

The proximal member 34 of the adapting member 30 has a front wall 31, an upper wall 48, and a pair of side pieces 37. The side pieces 37 define a pair of guiding grooves 42. Locking features 44, which may be in the form of tabs, are formed in the guiding grooves 42 for engaging corresponding locking features 46 in the cover 32. The locking features 46 of the cover 32 are movable in the guiding grooves 42.

Referring to FIG. 4, the proximal member 34 defines a hollow space 52 between the upper wall 48, the front wall 31 and the side pieces 37. The front wall 31 has a cutout 54 adjacent to the proximal ends 33 of the side walls 80. The side pieces 37 of the proximal member 34 each include a first portion 50, a second portion 51, and a spring arm 40 connected adjacent to the upper wall 48. The spring arms 40 are deflectable relative to the first portions 50 and the second portions 51 and define the guiding grooves 42 extending along the longitudinal direction X. The proximal member 34 includes a pair of contact surfaces 56 (clearly shown in FIGS. 5 and 6) adjacent to the second portions 51. The contact surfaces 56 extend along a direction parallel to a Z direction, which extends along the height of the adaptor assembly 26 or the wiper blade 12 and is perpendicular to the longitudinal direction X. The contact surfaces 56 function to contact and abut against a front (or proximal) edge of a wiper arm, which will be described in more detail below.

Referring to FIG. 6, the distal member 36 defines a substantially inverted U shape and includes a base portion 60 and a pair of legs 62 extending downwardly from opposing sides of the base portion 60. The base portion 60 is disposed between the pair of legs 62 and extends into the cavity 82. The base portion 60 includes an upper surface 63 and a pair of recessed portions 64. The recessed portions 64 extend along a longitudinal direction X and each define a bottom surface 65 recessed from the upper surface 63. The bottom surfaces 65 may or may not be parallel to the upper surface 63. The distal member 36 further includes a protrusion 66 extending upwardly from the upper surface 63.

The pair of legs 62 each includes a securing feature 68, which may be in the form of a cutout portion. The securing feature 68 includes a vertical surface 70 (clearly shown in FIG. 2), a first angled surface 72, a first horizontal surface 74, a second angled surface 76, and a second horizontal surface 78 connected in that order. The vertical surface 70, the first angled surface 72, the first horizontal surface 74 and the second angled surface 76 jointly defines a tab receiving space 69.

Referring to FIGS. 5 and 8, the pin 27 to be inserted into the corresponding groove 29 of the base member 24 is provided adjacent to a bottom side of the adaptor assembly 26 and across the elongated cavity 82. The pin 27 extends along a transverse direction Y, which is perpendicular to the longitudinal direction X and the vertical direction Z. The transverse direction Y is parallel to a wiping direction of the wiper blade 12 when the wiper blade 12 is driven by the wiper arms 200, 300, 400, 500, 700, and 800.

The side walls 80 each include an inner surface 81, an outer surface 83 and an upper edge 85. A transverse member 84 is disposed in the cavity 82 and connects the inner surfaces 81 of the side walls 80. The transverse member 84 includes a first transverse section 86, a second transverse section 87, and an opening 88 therebetween. A pair of lateral flanges 92 extend proximally from the first transverse section 86 and inwardly from the inner surfaces 81 of the side walls 80. The lateral flanges 92 are aligned with the recessed portions 64 of the distal member 36 along the longitudinal direction X. The side walls 80 have through holes 94 aligned along the transverse direction Y. A pair of restraining members 96 extend inwardly from the upper edges 85 of the side walls 80 in the cavity 82.

As clearly shown in FIG. 6, the side walls 80 further include recessed portions 100 recessed from the outer surface 83 and formed adjacent to the proximal member 34. The recessed portions 100 defines a substantially L shape and includes a vertical surface 102 and a horizontal surface 104. A pair of first longitudinal members 106 extend laterally and outwardly from the outer surfaces 83 of the side walls 80. The first longitudinal members 106 include horizontal surfaces 108 connected to the contact surfaces 56 of the proximal member 34. The horizontal surfaces 108 and the contact surfaces 56 define an L shape. The horizontal surfaces 108 are aligned with the second horizontal surfaces 78 of the securing features 68 along the longitudinal direction X. The horizontal surfaces 108 and the second horizontal surfaces 78 may extend in the same plane to jointly define a seat for supporting a wiper arm.

A pair of second longitudinal members 120 extend outwardly and laterally from the outer surfaces 83 of the side walls 80 and also outwardly and laterally from the first longitudinal members 106. The second longitudinal members 120 include a pair of horizontal surfaces 122. The horizontal surfaces 104 of the recessed portions 100, the horizontal surfaces 108 of the first longitudinal members 106, and the horizontal surfaces 122 of the second longitudinal members 120 are not disposed in the same plane, thereby defining steps therebetween. It is understand and appreciated that the horizontal surfaces 104, the horizontal surfaces 108, and the horizontal surfaces 122 may be disposed in the same plane without departing from the scope of the present disclosure.

As shown in FIGS. 5 and 6, a space 140 is defined between the first longitudinal member 106 and the pin 27. As shown in FIG. 7, recesses 138 are formed in the space 140 and at bottom surfaces 137 of the side walls 80 of the adapting member 30. Shoulders 139 are defined at the recesses 138.

Referring to FIGS. 1 and 9, the cover 32 includes an upper portion 140 and a pair of side portions 142 extending vertically and downwardly from the upper portion 140. The upper portion 140 and the side portions 142 define a space 144 therebetween for receiving the proximal member 34 of the adapting member 30. The side portions 142 each include a locking feature 46 in the form of a tab. The cover 32 is slidingly mounted to the adapting member 30 by inserting the locking features 46 in the guiding grooves 42. The cover 32 includes a distal edge 148 and a cutout 150 adjacent to the distal edge 148.

Referring to FIGS. 10 and 11, the cover 32 is movable between an open position and a closed position. When the cover 32 is in the closed position, the distal edge 148 of the cover 32 is located distally (or rearwardly) of the vertical surfaces 102 of the L-shaped recessed portions 100 and consequently covers a portion of the L-shaped recessed portions 100. When the cover 32 is in the open position, the distal edge 148 of the cover 32 is located proximally (or forwardly) of the vertical surfaces 102 of the L-shaped recessed portions 100.

To move the cover 32 from the closed position to the open position, the spring arms 40 are pressed inwardly (toward the hollow space 52 of the proximal member 34 and biased toward each other so that the locking features 46 of the cover 32 are disengaged from the locking features 44 of the spring arms 40. As a result, the locking features 46 of the cover 32 can move in the guiding grooves 42 proximately (or forwardly) in the longitudinal direction X. Further forward movement of the cover 32 is restrained by the first portion 50.

To move the cover 32 from the open position to the closed position, the cover 32 can be moved distally or rearwardly without depressing the spring arms 40. After the locking features 46 of the cover 32 slide over the locking features 44 in the guiding grooves 42 of the spring arms 40, the locking features 46 of the cover 32 and the locking features 44 of the spring arms 40 engage each other. The spring arms 40 return to their original position to push the locking features 44 and 46 together. Therefore, the cover 32 is locked by the locking features 46 and 44 in the closed portion.

Referring back to FIG. 2, the first longitudinal members 106 and optionally the second horizontal surfaces 78 of the securing features 68 define the first seat 160 for supporting the first wiper arm 200 and the third wiper arm 400. The first seat 160 may also support the fourth wiper arm 500 through an intermediate member 550 (shown in FIG. 36). The second longitudinal members 120 define the second seat 162 and supports the second wiper arm 300.

The transverse member 84 may cooperate with the upper surface 63 of the base portion 60 of the distal member 36 to form the third seat 164 and supports the fifth wiper arm 600, which has a width smaller than the distance between the side walls 80 of the adapting member 30. The lateral flanges 92 and the recessed portions 64 of the base portion 60 of the distal member 36 may jointly define the fourth seat 166 for supporting the sixth wiper arm 700, which has a width smaller than the distance between the side walls 80 of the adapting member 30. One of the outer surfaces 83 of the side walls 80 may define a fifth seat 168 to friction-fit with a seventh wiper arm 800.

It is understood and appreciated that the top edges 98 of the side walls 80 may be configured to engage or not engage the first, second, and third wiper arms 200, 300 and 400 when the first, second, and third wiper arms 200, 300, 400 are mounted depending on the sizes of these wiper arms. Therefore, the top edges 93 of the side walls 80 may constitute a part of one of the seats 160 and 162 for supporting the first, second and third wiper arms 200, 300, and 400. Alternatively, the top edges 93 of the side walls 80 alone may function as another seat for supporting a wiper arm thereon.

First Wiper Arm

Referring to FIGS. 12 and 13, the adaptor assembly 26 according to the present disclosure can be adapted for a first wiper arm 200. The first wiper arm 200 include an elongated arm body 201 to be connected to a wiper arm driving mechanism (not shown) and a front connecting end 202. The front connecting end 202 includes a substantially U-shaped housing 203, an insertion portion 204 extending forwardly from the U-shaped housing 202, a pair of tabs 206. The U-shaped housing 202 defines a pair of side walls 210 having front edges 208 and bottom edges 215. The tabs 206 are formed on the sidewalls 210 and have rear edges 213. The rear edges 213 define an acute angle relative to the longitudinal direction X.

Referring to FIG. 14, to mount to the first wiper arm 200 to the adaptor assembly 26, the cover 32 of the adaptor assembly 26 is first moved to the open position. Next, the tabs 216 are inserted into the tab receiving spaces 69 of the securing features 68 of the distal member 34 at an angle relative to the longitudinal direction X. Thereafter, the first wiper arm 200 is pivoted around the securing features 68 toward the proximal member 34 until the front edges 208 of the first wiper arm 200 abut against the contact surfaces 56 of the proximal member 34. Finally, the cover 32 is moved to the closed position. Therefore, the first wiper arm 200 is secured to the wiper blade 12 through the adaptor assembly 26.

Referring to FIGS. 15-18, when the first wiper arm 200 is mounted on the adaptor assembly 26, the tabs 206 of the first wiper arm 200 is received in the tab receiving spaces 69 of the securing feature 68 of the distal member 36. The front edges 208 of the first wiper arm 200 abut against the contact surfaces 56 of the proximal member 34. The insertion portion 204 of the first wiper arm 200 is received in the cutout 54 (FIG. 9) of the upper wall 48 of the proximal member 34. The bottom edges 215 of the first wiper arm 200 are supported on the horizontal surfaces 108 of the first longitudinal members 106 and on the second horizontal surfaces 78 of the securing features 68. When the cover 32 is moved to the closed position, the insertion portion 204 is received in the cutout 150 of the upper portion 140 of the cover 32. In the closed position, the cover 32 is disposed above the insertion portion 204 and a portion of the U-shaped housing 203 of the first wiper arm 200, thereby preventing the first wiper arm 200 from moving in the Z direction. The contact surfaces 56 and the securing features 68 clamp the first wiper arm 200 therebetween and prevent the first wiper arm 200 from moving in the longitudinal direction X. The side walls 80 of the adapting member 30 may engage the inner surfaces of the first wiper arm 200 and prevent the first wiper arm 200 from moving in the transverse direction Y.

It is understood and appreciated that the shape of the securing feature 68 may be similar to or different from the tabs 206 of the first wiper arm 200 as long as the tabs 206 can be received in the securing features 68.

Second Wiper Arm

Referring to FIGS. 19 and 20, the adaptor assembly 26 according to the teachings of the present disclosure is adapted for a second wiper arm 300. The second wiper arm 300 includes an elongated arm body 302, and a connecting housing 304 offset from a longitudinal axis X of the arm body 302. The connecting housing 304 defines a substantially U shaped and includes an upper wall 306, a first side wall 308 adjacent to the elongated arm body 302, and a second side wall 310 opposite to the first side wall 308 and distal of the elongated arm body 302. An opening 312 is formed in the upper wall 306. A first angled wall 314 connects the first side wall 308 and the elongated arm body 302. A second angled wall 316 connects the second side wall 310 and the elongated arm body 302. The first side wall 308 and the second side wall 310 each include a bottom edge 320.

A pair of first extensions 318 are formed on the bottom edges 320 of the first side wall 308 and the second side wall 310. A second extension 322 extends perpendicularly from the first extension 318 of the first side wall 308. The first extension 318 and the second extension 322 of the first side wall 308 define an L shape.

Referring to FIG. 21, to mount the second wiper arm 300 to the adaptor assembly 26, the cover 32 of the adaptor assembly 26 is moved to the open position, the connecting housing 304 of the second wiper arm 300 is placed above the adaptor assembly 26 and the second extension 322 is aligned with the vertical surface 102 of the L-shaped recessed portion 100 immediately below the second extension 322. The second wiper arm 300 is then moved down toward the adaptor assembly 22. The second extension 322 moves along the vertical surface 102 of the L-shaped recessed portion 100 until the second extension 322 reaches the horizontal surface 104 of the L-shaped recessed portion 100.

Thereafter, the second wiper arm 300 is moved distally or rearwardly in the longitudinal direction X to move the second extension 322 along the horizontal surface 104 of the L-shaped recessed portion 100. The second extension 322 continues to be moved to an adjacent one of the spaces 140 between the first longitudinal member 106 and the pin 27. The second extension 322 continues to be moved to and received in the recesses 138 at the bottom surface 137 of the adapting member 30. The shoulder 139 provides positioning of the second wiper arm 300 and prevents the second wiper arm 300 from further movement. Finally, the cover 32 is moved to the closed position to secure the second wiper arm 300 on the adapting member 30.

As shown in FIGS. 22-26, when the second wiper arm 300 is mounted on the adaptor assembly 26, the bottom edges 320 of the second wiper arm 200 are supported on the horizontal surfaces 122 of the second longitudinal members 120. The second extension 322 is disposed in one of the recesses 138. When the cover 32 is in the closed position, the cover 32 covers a part of the connecting housing 304 to prevent the second wiper arm 300 from moving in the vertical direction Z.

Third Wiper Arm

Referring to FIGS. 27-29, the adaptor assembly 26 according to the teachings of the present disclosure can be adapted for a third wiper arm 400. The third wiper arm 400 includes a substantially U-shaped housing 402 and a first protrusion 404 extending forwardly from the U-shaped housing 402. The U-shaped housing 402 includes an upper wall 406, a pair of front edges 408 and a pair of side walls 410. The side walls 410 each includes a bottom edge 424 and a tab 412 having a rear edge 414. The rear edges 414 are perpendicular to the longitudinal direction X. The substantially U-shaped housing 402 defines a first through hole 416 and a second through hole 418 in the upper wall 406. A tab 420 is formed in the first through hole 416. The front edges 408 and the rear edges 414 define a distance D3 therebetween.

Referring to FIG. 30, to mount the third wiper arm 400 to the adaptor assembly 26, the cover 32 is moved to the open position. The second wiper arm 300 is oriented parallel to the longitudinal direction X and moved down to the adapting member 30 to make the front edges 480 contact the contact surfaces 56 of the proximal member 34 and to make the rear edges 414 contact the vertical surfaces 70 of the securing features 68 of the distal member 36. Finally, the cover 32 is moved to the closed position to lock the third wiper arm 400 on the adaptor assembly 26.

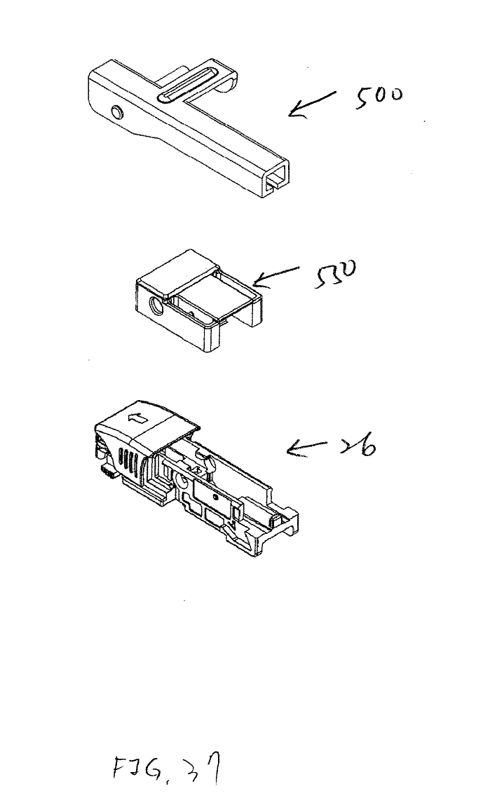

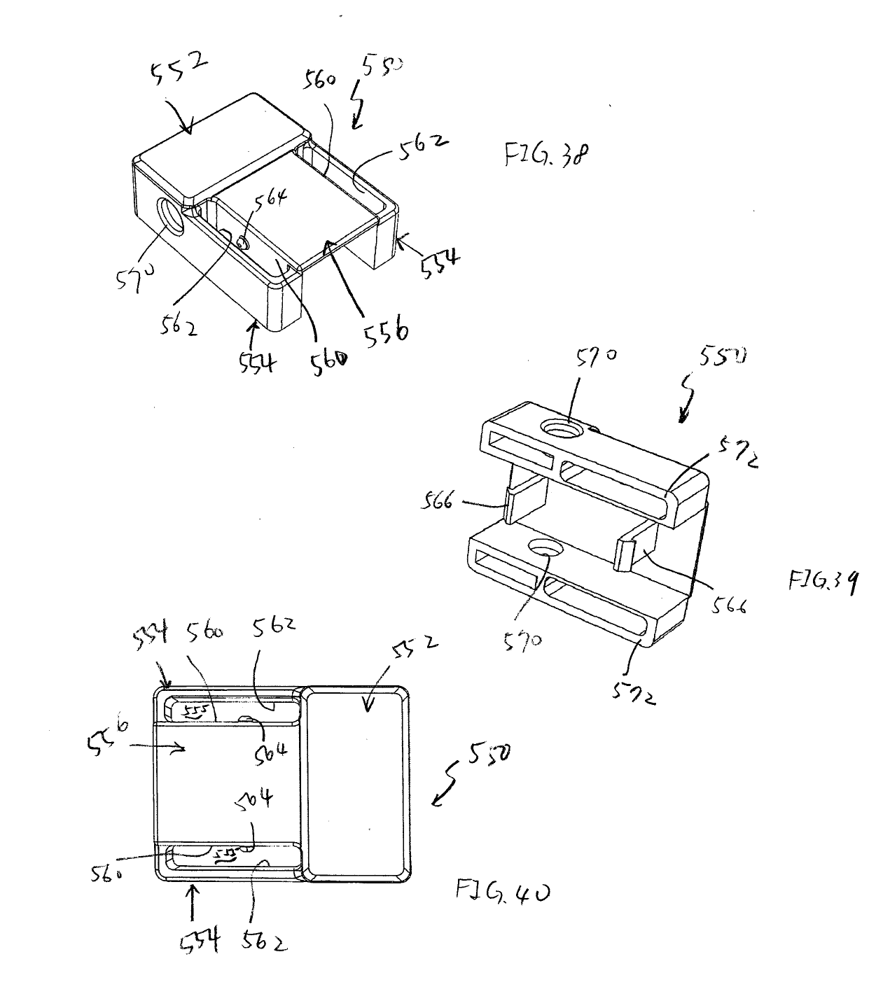

As shown in FIGS. 31-34, when the third wiper arm 400 is mounted on the adaptor assembly 26, the bottom edges 424 of the third wiper arm 400 is supported on the horizontal surfaces 108 of the first longitudinal members 106. Optionally, the bottom edges 424 of the third wiper arm 400 may also contact the second horizontal surfaces 78 of the securing features 68 of the distal member 36. The distance D4 (FIG. 33) between the contact surfaces 56 of the proximal member 34 and the vertical surfaces 70 of the securing features 68 of the distal member 36 is equal to or slightly smaller than distance D3 (FIG. 29) between the front edges 408 and rear edges 414 of the third wiper arm 400. Therefore, the third wiper arm 400 is clamped between the contact surfaces 56 of the proximal member 34 and the vertical surfaces 70 of the distal member 36. The tab 420 in the first through hole 416 of the third wiper arm 400 may or may not engage the protrusion 66 of the distal member 36. The cover 32 is then moved to the closed position to cover the front edge 408 of the third wiper arm 400 to prevent the third wiper arm 400 from moving in the Z direction.

Fourth Wiper Arm

Referring to FIGS. 35 and 36, the adaptor assembly 26 according to the present disclosure is adapted for a fourth wiper arm 500. The fourth wiper arm 500 includes an elongated arm member 502, an L-shaped leg 504, and a circular pin 506. The L-shaped leg 504 and the circular pin 506 extend laterally from the elongated arm member 502. The L-shaped leg 503 has a length, which is longer than the length of the circular pin 76, measured from a side wall of the elongated arm member 502, from which the L-shaped leg 503 and the circular pin 76 extend. The L-shaped leg 503 defines a bent free end 574.

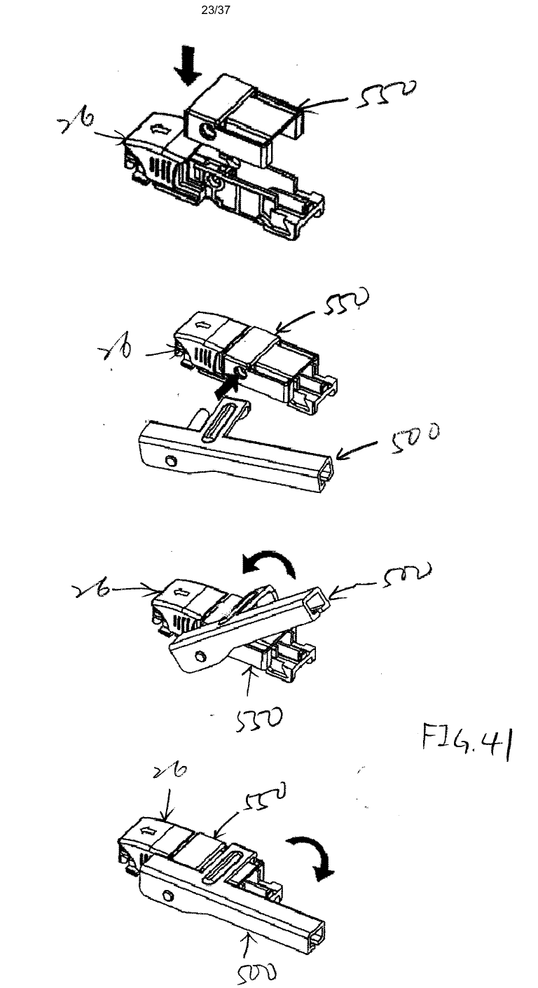

Referring to FIGS. 36 to 40, to mount to the fourth wiper arm 500 to the adaptor assembly 26, an intermediate member 550 is used. The intermediate member 550 may be interpreted as a part of the fourth wiper arm 500 or a part of the adaptor assembly 26. The intermediate member 550 includes a front portion 552, a pair of slotted portions 554, and a connecting plate 556 between the slotted portions 554. The slotted portions 554 each defines an inner surface 560 and an outer surface 562. A slot 555 is defined between the inner surface 560 and the outer surface 562. A bumper 564 is formed on each of the inner surfaces 560. A pair of legs 566 extending downwardly from the connecting plate 556. The intermediate member 550 defines a pair of through holes 570. The slotted portions 554 define bottom edges 572.

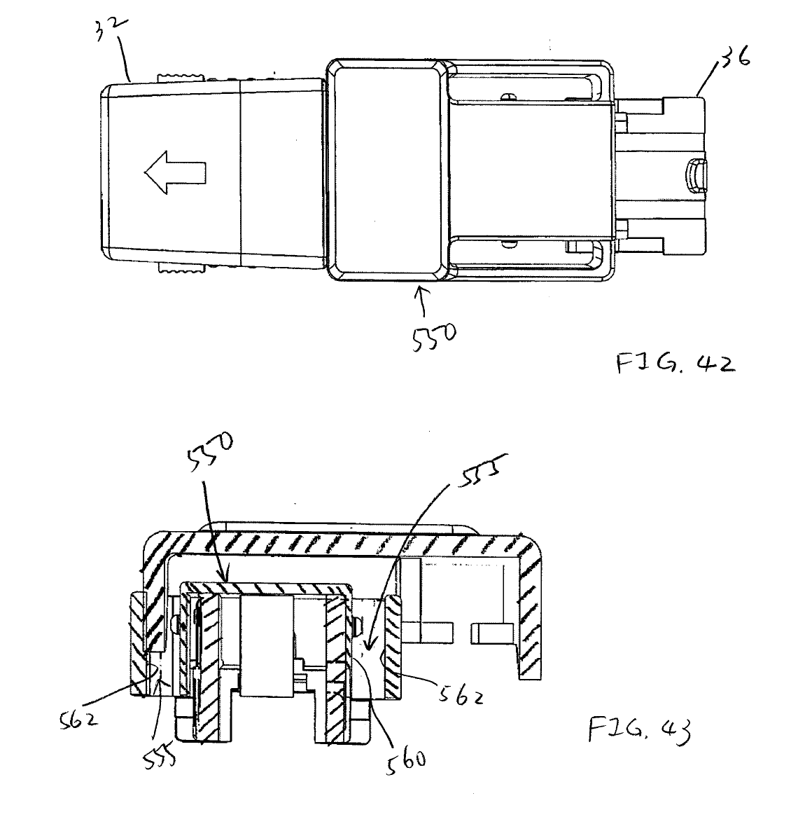

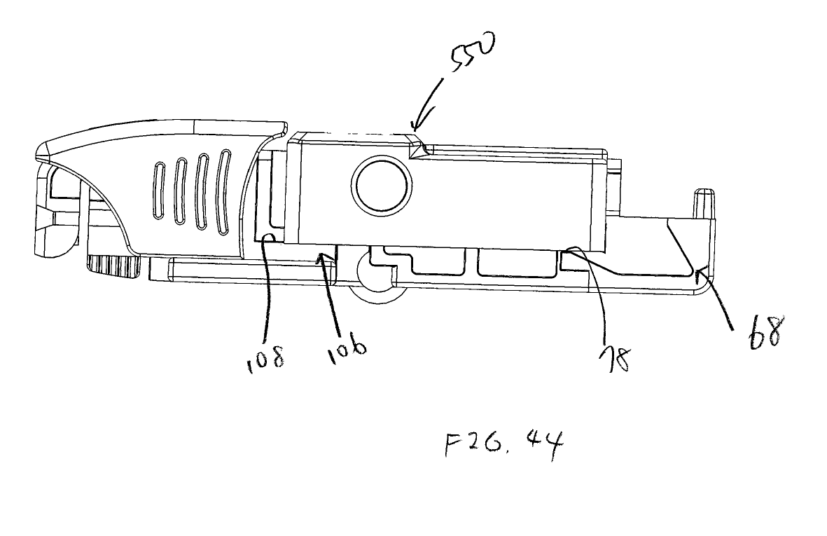

Referring to FIGS. 41-44, to mount the fourth wiper arm 500 to the adaptor assembly 26, the intermediate member 550 is placed on the adapting member 30 of the adaptor assembly 26. The intermediate member 550 may be loosely or firmly mounted on the adapting member 30 of the adaptor assembly 26. The through holes 570 of the intermediate member 550 are aligned with the through holes 94 of the adapting member 30 of the adaptor assembly 26. Moreover, the bottom edges 572 of the intermediate member 550 are supported on the horizontal surfaces 108 of the first longitudinal members 106 and the horizontal surfaces 78 of the securing features 68 of the distal member 36.

Next, the circular pin 504 of the fourth wiper arm 500 is inserted into the through holes 570 of the intermediate member 550 and consequently, the through holes 94 of the adaptor assembly 26 at an angle relative to the adaptor assembly 26. The fourth wiper arm 700 is then pivoted around the circular pin 504 to insert the bent free end 574 of the L-shaped leg 504 into an adjacent one of the slots 555 and engages the outer surface 562 of the slotted portion 554 in a friction-fit manner. The fourth wiper arm 500 does not contact the inner surface 560 of the slotted portion 554, particularly in the presence of the bumper 564. Therefore, the fourth wiper arm 500 is secured to the adaptor assembly 26 through the intermediate member 550.

Fifth Wiper Arm

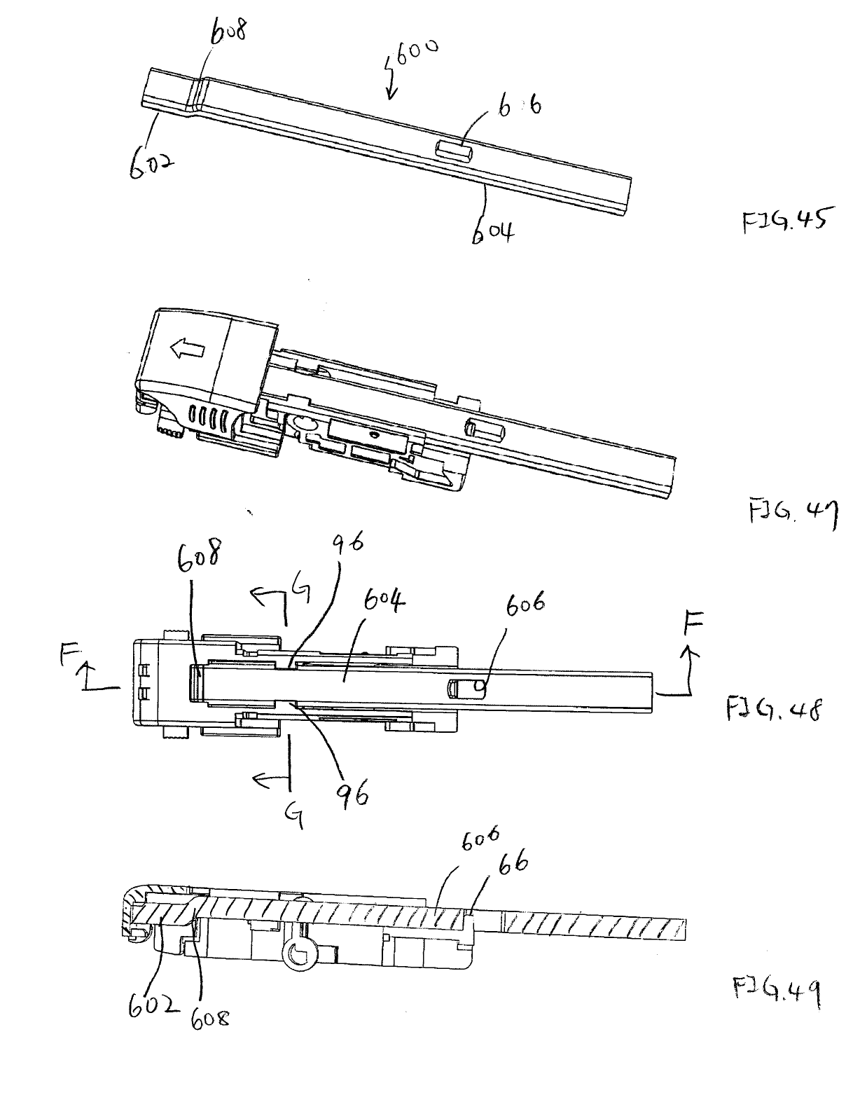

Referring to FIG. 45, the adaptor assembly 26 according to the present disclosure is adapted for a fifth wiper arm 600. The fifth wiper arm 600 defines a substantially elongated plate configuration and includes a first elongated plate member 602 and a second elongated plate member 604 defining an opening 606. The first elongated plate member 602 and the second elongated plate member 604 define a step 610 therebetween.

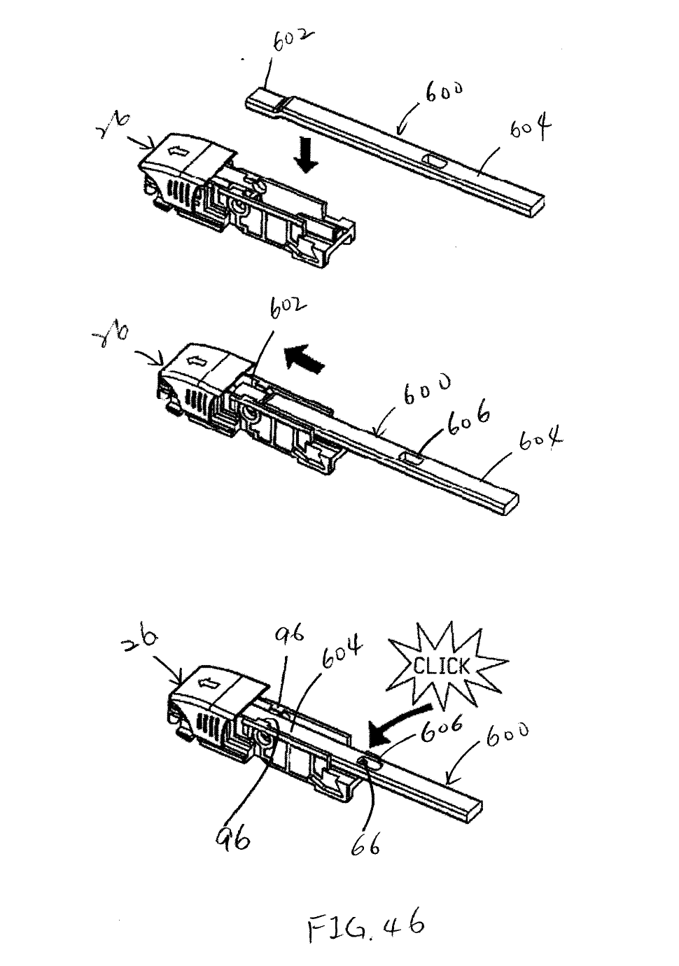

Referring to FIG. 46, to mount the fifth wiper arm 600 to the adaptor assembly 26, the cover 32 maintains in the closed position. The fifth wiper arm 600 is inserted into the cavity 82 of the adapting member 30. Inserting the fourth wiper arm 500 into the cavity 82 of the adapting member 30 may be achieved by moving the wiper arm 600 in the Z direction toward the adaptor assembly 26, followed by moving the fifth wiper arm 600 toward the proximal member 34 along the X direction. The fifth wiper arm 600 is moved along the X direction until the protrusion 66 of the distal member 36 is inserted into the opening 606 of the fifth wiper arm 600.

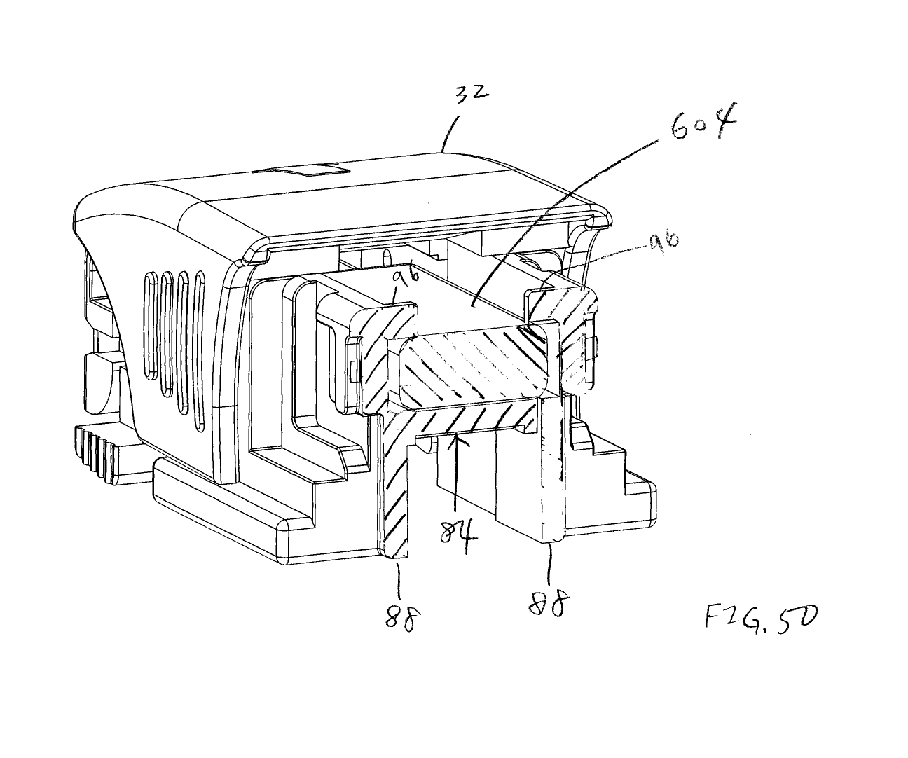

As shown in FIGS. 47 to 52, the fifth wiper arm 600 is supported on the transverse member 84 in the cavity 82 and the upper surface 63 of the base portion 60 of the distal member 36. The first plate member 602 is inserted into the hollow space 52 of the proximal member 34 and contacts the front wall 31 of the proximal member 34. Therefore, the fifth wiper arm 600 is restrained from moving in the longitudinal direction X by the front wall 31 of the proximal member 34 and the protrusion 66 of the distal member 36.

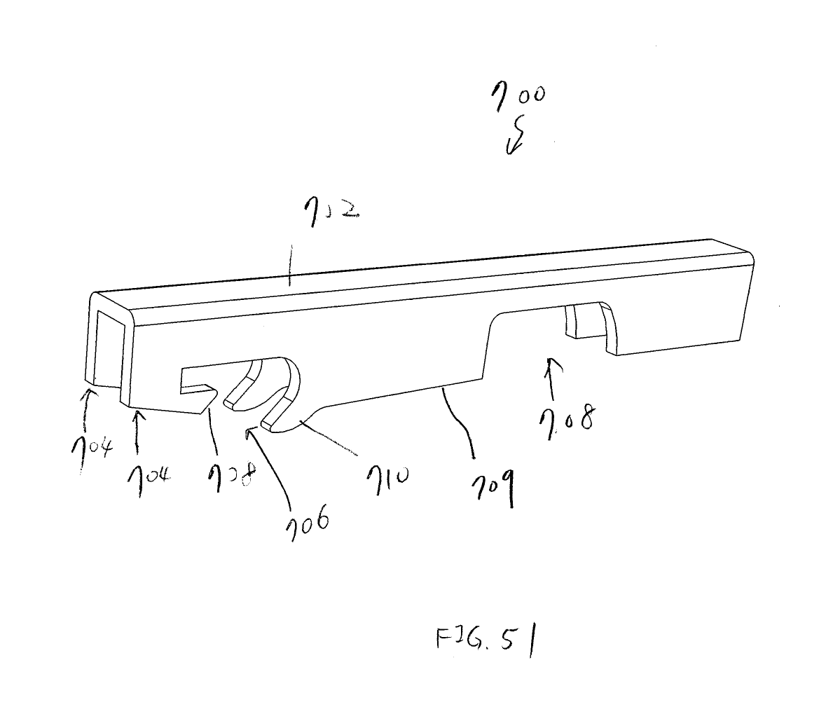

As clearly shown in FIGS. 49 and 50, the second plate member of the fifth wiper arm 600 is received between the pair of restraining members 96 and the transverse member 84. The restraining members 96 engages the fifth wiper arm 600 to prevent the fifth wiper arm 600 from moving in the transverse direction Y and the vertical direction Z.

Sixth Wiper Arm

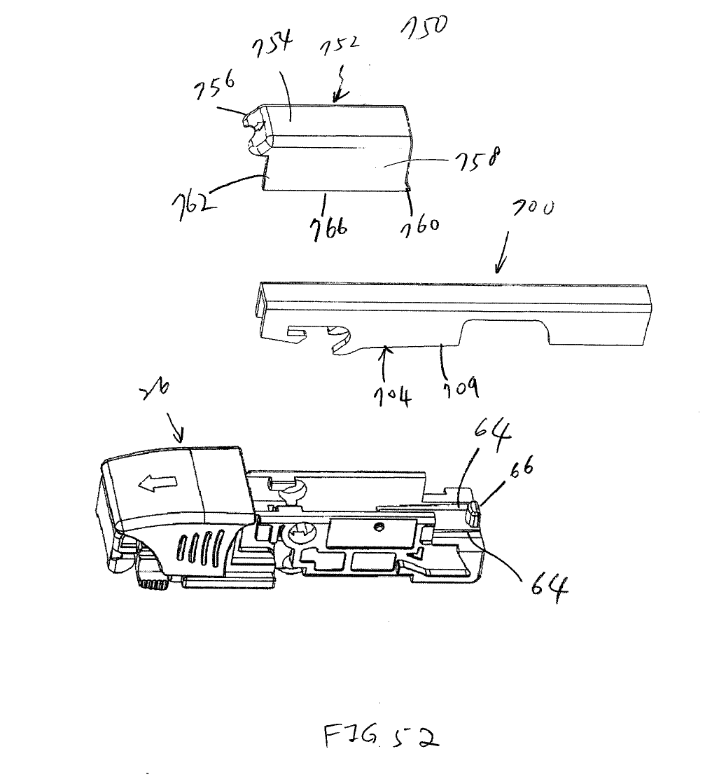

Referring to FIG. 51, the adaptor assembly 26 according to the teachings of the present disclosure is adapted for a sixth wiper arm 700. The fifth wiper arm 700 includes a substantially U housing defining an upper wall 702, a pair of sidewalls 704. The side walls 704 each define a first cutout portion 706 at a second cutout portion 708, and a middle portion 709 therebetween. The side walls 706 each includes a first arm 708 and a second arm 710. The first arm 708 extends rearwardly (or distally) into the first cutout portion 706. The second arm 710 extends forwardly (or proximately) into the first cutout portion 706.

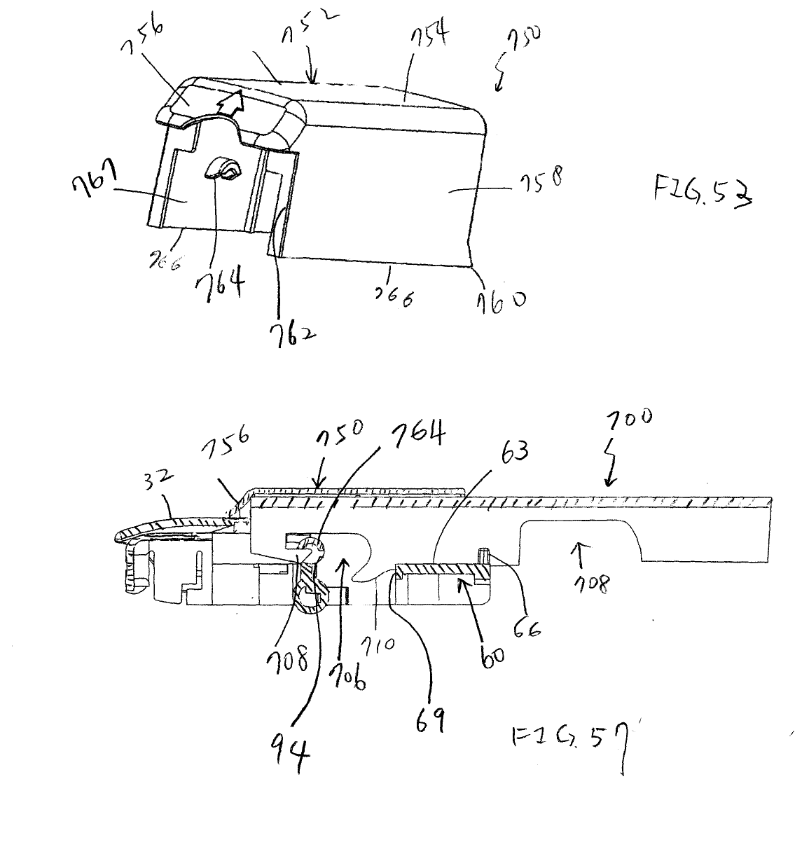

Referring to FIGS. 52 and 53, to secure the sixth wiper arm 700 to the adaptor assembly 26, a securing housing 750 is used. The securing housing 750 may be interpreted as a part of the adaptor assembly 26, a part of the sixth wiper arm 700, or a separate component from the adaptor assembly 26 and the sixth wiper arm 700. The securing housing 750 defines a substantially U-shaped housing 752 and includes an upper wall 754, a front member 756, a pair of side walls 758, and a pair of tabs 760 extending from the side walls 758, and a pair of bottom edges 766. A pair of protrusions 764 are formed on the inner surfaces 767 of the side walls 758.

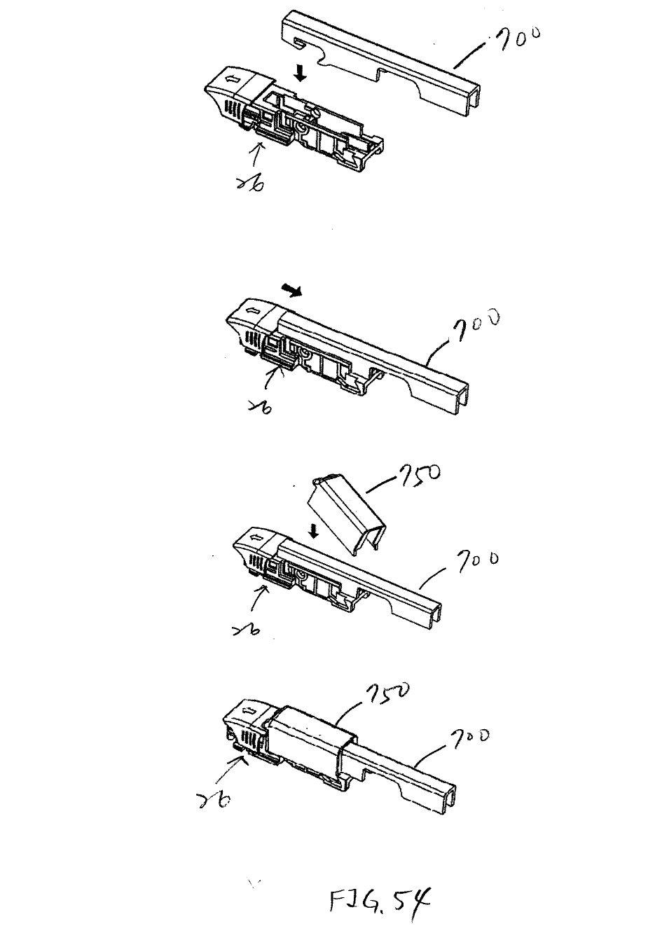

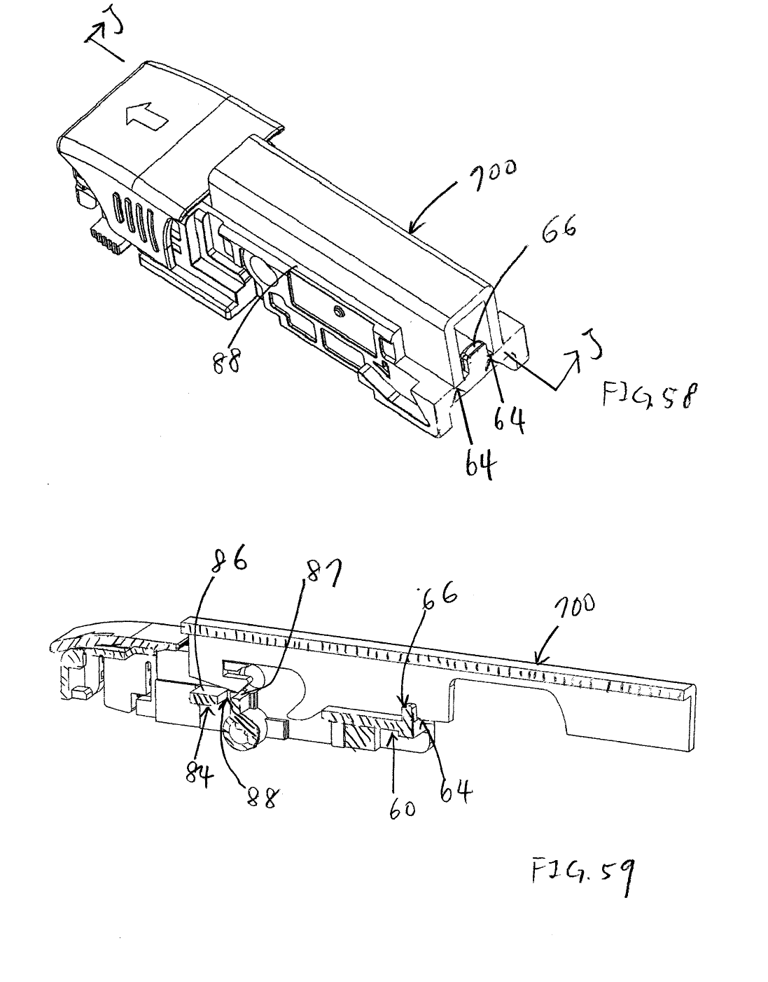

Referring to FIGS. 54 to 59, to mount the sixth wiper arm 700 to the adaptor assembly 26, the cover 32 remains in the closed position. The sixth wiper arm 700 is placed on top of the adaptor assembly 26 and moved along the vertical direction Z until the sixth wiper arm 700 is received in the cavity 82 of the adaptor assembly 26. The middle portions 709 of the side walls 704 of the fifth wiper arm 700 are disposed in the recessed portions 64 of the distal member 36.

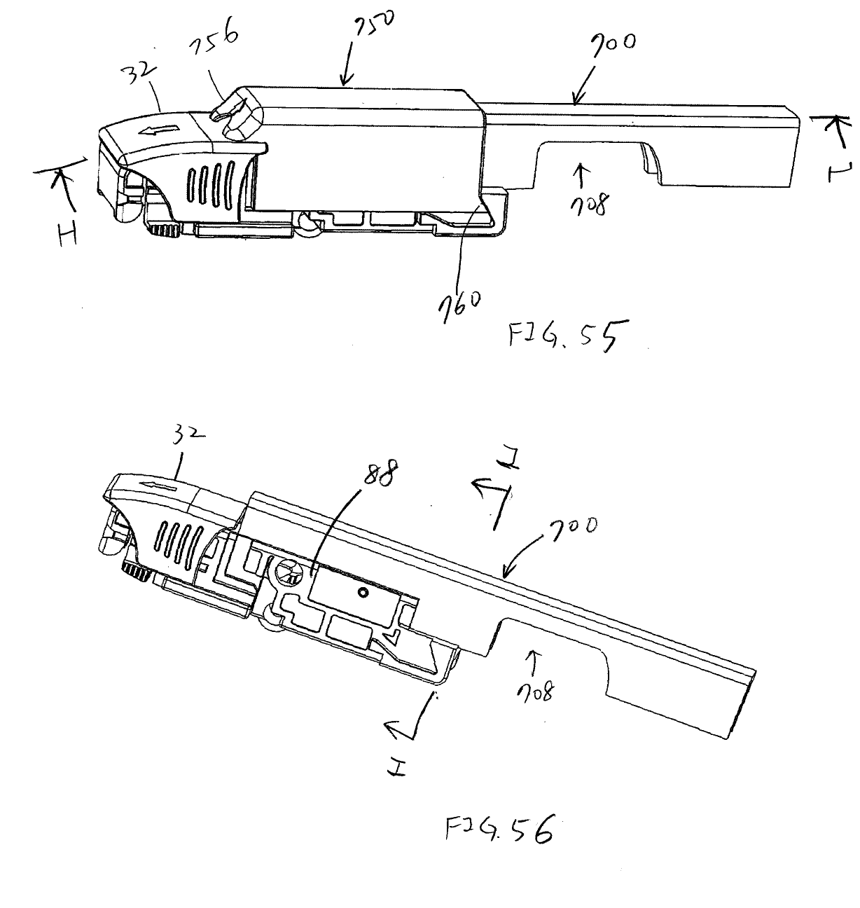

Next, the sixth wiper arm 700 is moved distally or rearwardly in the longitudinal direction X until the second arms 710 of the sixth wiper arm 700 contacts a front edge 69 (FIG. 57) of the base portion 60 of the distal member 36. Thereafter, the securing housing 750 is placed on top of the fifth wiper arm 600 by inserting the tabs 760 in the tab receiving spaces 69 of the securing features 68, followed by pivoting the securing housing 750 down until the front edges 762 of the securing housing 750 engage the contact surfaces 56 of the proximal member 34. Therefore, the securing housing 750 is secured between the contact surfaces 56 of the proximal member 34 and the securing feature 68 of the distal member 36. Therefore, the sixth wiper arm 700 is secured to the adaptor assembly 26 by the securing housing 750.

As clearly shown in FIGS. 57-59, when the sixth wiper arm 700 is placed in the cavity 82 of the adapting member 30, the first arms 708 may contact the transverse member 84 in the cavity 82 and the middle portions 709 of the side walls 704 of the sixth wiper arm 700 are received in the recessed portions 64 of the distal member 36. The second arms 710 of the sixth wiper arm 600 may abut against the front edge 63 (FIG. 57) of the base portion 60 of the distal member 36. The first arms 708 and the second arms 710 may be used to position the sixth wiper arm 700 in place and prevent the sixth wiper arm 700 from moving in the longitudinal direction X.

Mounting of the securing housing 750 to the adaptor assembly 26 is similar to mounting of the first wiper arm 200 to the adaptor assembly 26. The bottom edges 766 of the securing housing 750 are supported on the horizontal surfaces 108 of the first longitudinal members 106 and, optionally, the second horizontal surfaces 78 of the securing feature 68. Additionally, when the securing housing 750 is positioned in place on the adaptor assembly 26, the protrusions 764 of the securing housing 750 are inserted into the through holes 94 of the side walls 80 of the adapting member 30 to further secure the securing housing 750 on the adaptor assembly 26.

Seventh Wiper Arm

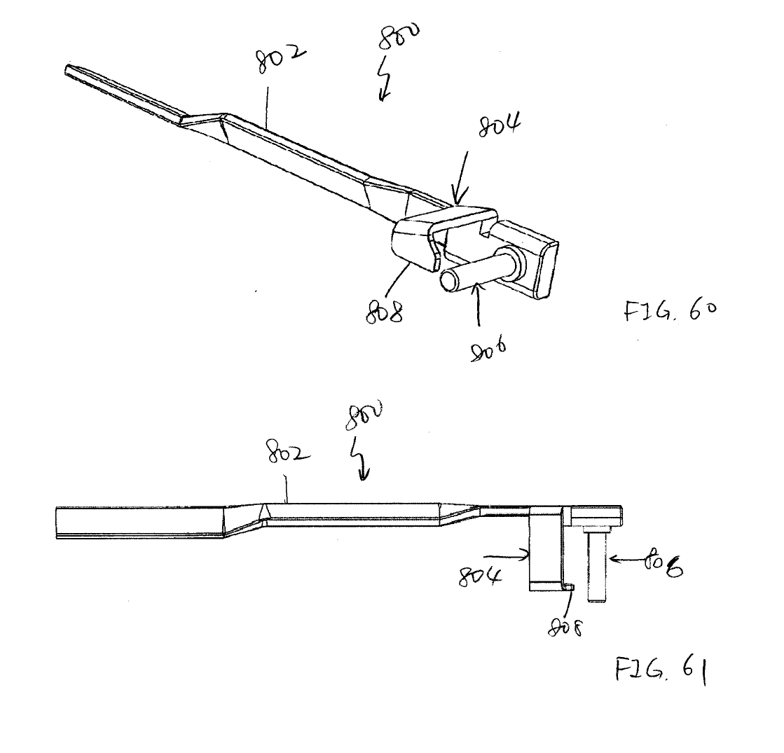

Referring to FIGS. 60 and 61, the adaptor assembly 26 according to the teachings of the present disclosure is adapted for a seventh wiper arm 800. The seventh wiper arm 800 includes an elongated arm body 802, an L-shaped leg 804 extending laterally from the elongated arm body 802, and a circular pin 804 extending laterally from the elongated arm body 802. The L-shaped leg 804 is shorter than the circular pin 806 and has a bent free end 808.

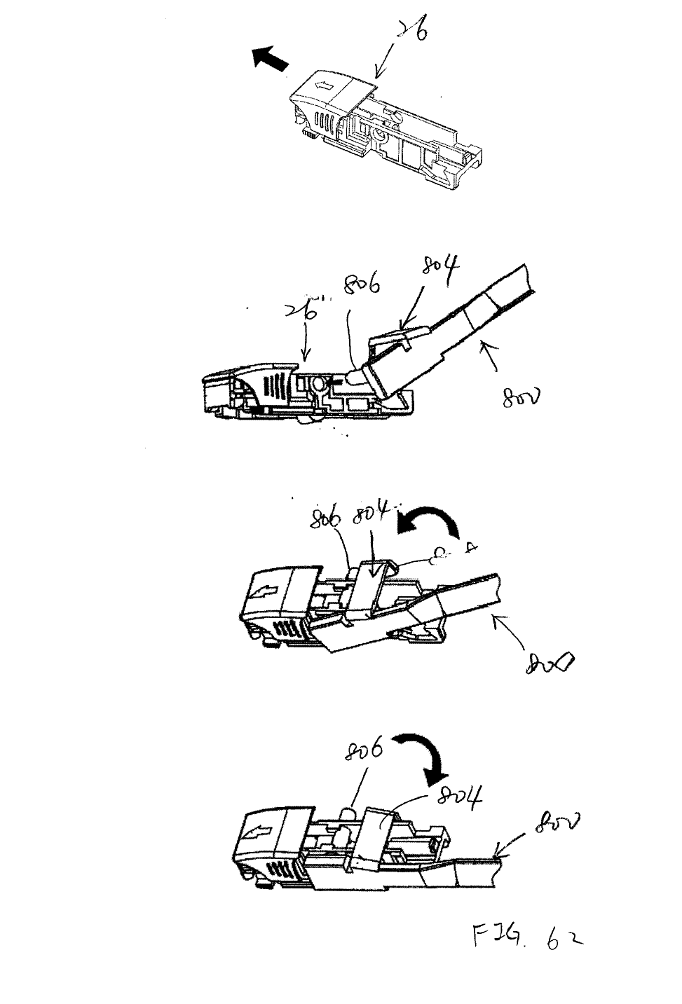

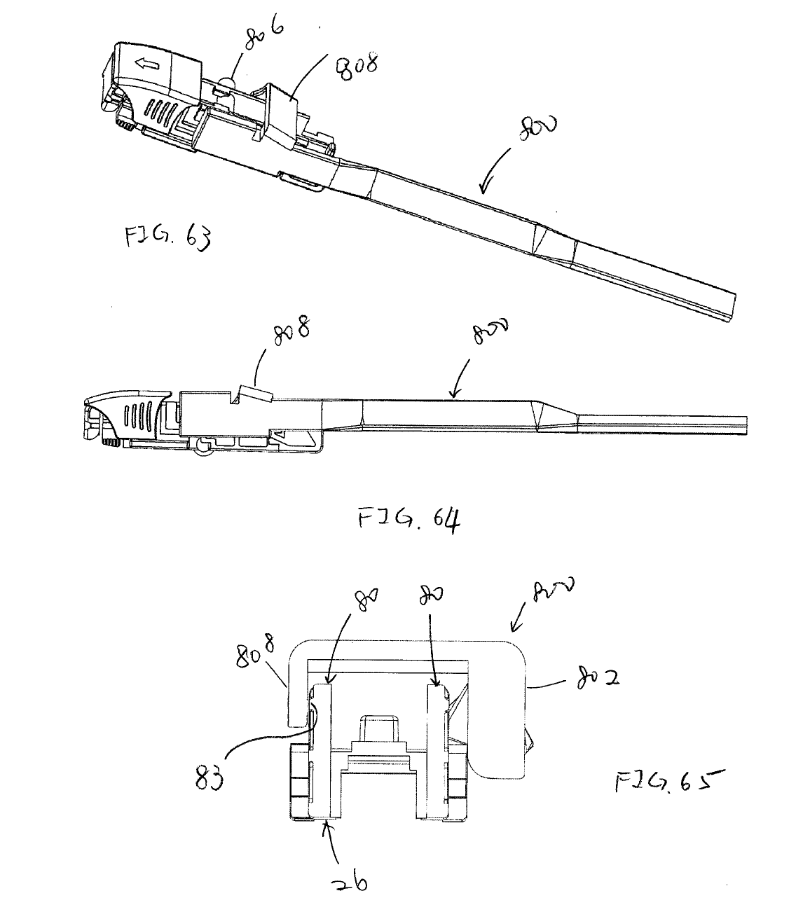

Referring to FIGS. 62 to 65, to mount the seven wiper arm 800 to the adaptor assembly 26, the seven wiper arm 800 is mounted at an angle relative to the longitudinal direction X by inserting the circular pin 804 into the through holes 94 of the adapting member 30 of the adaptor assembly 26. The cover 32 remains in the closed position. Next, the seventh wiper arm 800 is pivoted around the circular pin 806 to make the elongated arm body 802 disposed parallel to the longitudinal direction X. In this position, the bent free end 808 of the L-shaped leg 804 of the seventh wiper arm 800 engages the adjacent one of the outer surfaces 83 of the side walls 80 of the adapting member 30. The friction engagement between the bent free end 808 of the L-shaped leg 804 and the outer surface 83 of the side walls 80 secures the seventh wiper arm 800 on the adaptor assembly 26.

In summary, the adaptor assembly 26 of the present disclosure provides a plurality of seats for supporting a plurality of wiper arms. The seats may be provided laterally from the side walls 80 of the adapting member 30 (whether in the cavity 82 or outwardly from the side walls 80), at the side walls 80, or at the distal member 36. The proximal member 34 and the distal member 36 may define securing features adapted for securing features on the wiper arms. Additionally, an intermediate member may be used between a wiper arm and the adaptor assembly to mount the wiper arm to the adaptor assembly. Additionally, a movable or removable securing device may be used to secure the wiper arm on the adaptor assembly. The movable or removable securing device described in the present disclosure may be a cover 32, a securing housing 750, or an intermediate member 550. The movable or removable securing device may have other configurations and is not limited to the forms described herein.

This description is merely exemplary in nature and, thus, variations that do not depart from the gist of the disclosure are intended to be included within the scope of the disclosure. Further areas of applicability of the present invention will become apparent from the detailed description provided hereinafter. It should be understood that the description and specific examples, while indicating the preferred embodiments of the invention, are intended for purposes of illustration only and are not intended to limit the scope of this disclosure.

What is claimed is:

1. An adaptor assembly for connecting a wiper blade to a plurality of wiper arms, comprising
a proximal member;
a distal member;
a pair of side walls disposed between the proximal member and the distal member; and
a plurality of seats provided adjacent to the side walls, each seat configured differently from the other of the plurality of seats to support one of the plurality of wiper arms having different configurations;
wherein at least one of the plurality of wiper arms defines a U-shaped housing.

2. The adaptor assembly of claim 1, further comprising a first seat including a pair of first longitudinal members extending outwardly and laterally from the side walls.

3. The adaptor assembly of claim 2, wherein the pair of first longitudinal members are adapted to support a first wiper arm having a U-shaped housing thereon.

4. The adaptor assembly of claim 3, further comprising a second seat including a pair of second longitudinal members extending outwardly and laterally from the first longitudinal members.

5. The adaptor assembly of claim 4, wherein the second longitudinal members are adapted to support a second wiper arm having a U-shaped housing thereon, wherein the U-shaped housing of the first wiper arm has a first width and the U-shaped housing of the second wiper arm has a second width, the second width greater than the second width.

6. The adaptor assembly of claim 5, wherein the second wiper arm includes an elongated arm body and a U-shaped housing offset from the elongated arm body.

7. The adaptor assembly of claim 5, wherein the first seat adapted for supporting a third wiper arm having a U-shaped housing, an insertion portion, and a pair of tabs defining vertical edges relative a longitudinal direction of the third wiper arm.

8. The adaptor assembly of claim 7, wherein the U-shaped housing of the first wiper arm includes a top wall, a pair of side walls, an insertion portion extending forwardly from the top wall, and a pair of angled tabs defining an angle relative to a longitudinal direction of the first wiper arm.

9. The adaptor assembly of claim 8, wherein the adapting member defines a pair of securing features adapted to engage the angled tabs of the first wiper arm and the vertical tabs of the third wiper arm.

10. The adaptor assembly of claim 8, wherein the proximal member defines a cutout to receive the insertion portion of the first wiper arm and the insertion portion of the third wiper arm.

11. The adaptor assembly of claim 9, wherein the proximal member includes contact surfaces for contacting the first wiper arm and the third wiper arm, wherein the contact surfaces of the proximal member and the securing features of the distal member secure one of the first wiper arm and the third wiper arm therebetween.

12. The adaptor assembly of claim 3, further comprising an intermediate member supported one of the first longitudinal members and the second longitudinal members for engaging a fourth wiper arm.

13. The adaptor assembly of claim 12, wherein the fourth wiper arm includes an elongated arm body, a lateral L-shaped leg, and a lateral pin.

14. The adaptor assembly of claim 1, further comprising a third seat disposed between the side walls for supporting a fifth wiper arm.

15. The adaptor assembly of claim 14, wherein the side walls define a cavity and the third seat includes a transverse member disposed in the cavity, the fifth wiper arm having a width less than a distance between the side walls.

16. The adaptor assembly of claim 15, wherein the fifth wiper arm defines an elongated plate.

17. The adaptor assembly of claim 1, further comprising a fourth seat including a pair of lateral flanges adjacent to the proximal member, and a base portion adjacent to the distal member for supporting a sixth wiper arm having side walls defining first cutouts and second cutouts.

18. The adaptor assembly of claim 1, further comprising a fifth seat including an outer surface of the side walls for friction-fit with a seventh wiper arm.

19. The adaptor assembly of claim 18, wherein the seventh wiper arm includes an elongated arm body, an L-shaped leg and a pin extending laterally from the elongated arm body, the L-shaped leg being shorter than the pin.

20. The adaptor assembly of claim 1, further comprising a securing device for securing at least one of the plurality of the wiper arms on the adapting member.

21. The adaptor assembly of claim 20, wherein the securing device includes a cover moveably mounted to the proximal member.

22. The adaptor assembly of claim 20, wherein the securing device includes a U-shaped housing for covering a portion of the at least one of the plurality of the wiper arms.

23. The adaptor assembly of claim 1, wherein the plurality of wiper arms includes:
a first wiper arm including a U-shaped housing, an insertion portion extending forwardly from the U-shaped housing, and a pair of tabs each defining an angled rear edge relative to a longitudinal direction of the first wiper arm;
a second wiper arm including an elongated arm body and a U-shaped housing offset from the elongated arm body;
a third wiper arm including a U-shaped housing, an insertion portion extending forwardly from the U-shaped housing, and a pair of tabs each defining a rear edge perpendicular to a longitudinal direction of the third wiper arm;
a fourth wiper arm including an elongated arm body, an L-shaped leg, and a pin extending laterally from the elongated arm body, the L-shaped leg being longer than the pin;
a fifth wiper arm defining an elongated plate body and having a first plate member, a second plate member, and step between the first plate member and the second plate member;
a sixth wiper arm defining a U-shaped housing having a pair of side walls, the side walls each defining a first cutout and a second cutout;
a seventh wiper arm including an elongated arm body, an L-shaped leg, and a pin extending laterally from the elongated arm body, the L-shaped leg being shorter than the pin.

24. A adaptor assembly for mounting a plurality of wiper arms to a wiper blade, comprising:
a proximal member defining a cutout;
a distal member including a base portion and a pair of legs, the base portion defining an upper surface and a pair of recessed portions recessed from the upper surface;
a pair of side walls disposed between the proximal member and the distal member and defining a cavity, a part of the base portion extending into the cavity;
a pair of first longitudinal members disposed laterally from the side walls;
a pair of second longitudinal members disposed laterally from the first longitudinal members and laterally from the first longitudinal members;
a transverse member disposed in the cavity; and
a pair of lateral flanges disposed adjacent to the proximal member and aligned with the pair of recessed portions;
wherein the pair of the first longitudinal members define a first seat for supporting a first wiper arm, a third wiper arm, and a fourth wiper arm;
wherein the pair of the second longitudinal members define a second seat for supporting a second wiper arm;
wherein the transverse member and the upper surface of the base portion of the distal member define a third seat for supporting a fifth wiper arm;
wherein the pair of the lateral flanges and the recessed portions of the base portion of the distal member define a fourth seat for supporting a sixth wiper arm;
wherein the side walls between the proximal member and the distal member define a fifth seat for friction-fit with a seventh wiper arm.

25. The adaptor assembly of claim 24, further comprising a securing device for securing at least one of the plurality of wiper arms on the adaptor assembly.

26. A adaptor assembly for mounting a plurality of wiper arms to a wiper blade, comprising:
a proximal member;
a pair of side walls having proximal ends connected to the proximal member and distal ends opposite to the proximal ends, the side walls defining a cavity; and
at least one of a pair of first longitudinal members, a pair of second longitudinal members, a transverse member, and a base portion;
wherein the pair of first longitudinal members disposed laterally from the side walls for supporting a first wiper arm,
wherein the pair of second longitudinal members disposed laterally from the side walls and laterally from the first longitudinal members for supporting a second wiper arm,
wherein the transverse member disposed in the cavity for supporting a third wiper arm,
wherein the base portion disposed at the distal ends of the side walls for supporting a fourth wiper arm.

27. An adaptor assembly for mounting a wiper blade to a plurality of wiper arms, comprising:
a proximal member;
a distal member defining a securing feature;
a pair of side walls disposed between the proximal member and the distal member; and
a first seat provided at the side walls and adapted to support a first wiper arm and a second wiper arm, wherein the first wiper arm includes a first U-shaped housing and a pair of first securing tabs, the second wiper arm including a second U-shaped housing and a pair of second securing tabs having a configuration different from the first securing tabs, and
wherein the securing features are adapted to engage the first securing tabs and the second securing tabs.

28. The adaptor assembly of claim 27, wherein the securing features each include a plurality of surfaces defining a cutout portion.

29. The adaptor assembly of claim 28, wherein the plurality of surfaces include first surfaces and second surfaces different form the first surfaces, the first securing tabs contacting the first surfaces, the second securing tabs contacting the second surfaces.

30. A wiper blade and wiper arm assembly comprising:
a wiper blade;
an adaptor assembly mounted to the wiper blade, the adaptor assembly including a plurality of seats; and
a plurality of wiper arms including at least one wiper arm defining a U-shaped housing,
wherein the plurality of seats are adapted to support the plurality of wiper arms thereon.

31. The wiper blade and wiper arm assembly of claim 30, wherein the plurality of wiper arms include at least two wiper arms each defining a U-shaped housing of different sizes.

32. The wiper blade and wiper arm assembly of claim 30, wherein the plurality of wiper arms comprises at least two of a first wiper arm, a second wiper arm, a third wiper arm, a fourth wiper arm, a fifth wiper arm, a sixth wiper arm, and a seventh wiper arm,
the first wiper arm including a U-shaped housing, an insertion portion extending forwardly from the U-shaped housing, and a pair of tabs each defining an angled rear edge relative to a longitudinal direction of the first wiper arm,
the second wiper arm including an elongated arm body and a U-shaped housing offset from the elongated arm body,
the third wiper arm including a U-shaped housing, an insertion portion extending forwardly from the U-shaped housing, and a pair of tabs each defining a rear edge perpendicular to a longitudinal direction of the third wiper arm,
the fourth wiper arm including an elongated arm body, an L-shaped leg, and a pin extending laterally from the elongated arm body, the L-shaped leg being longer than the pin,
the fifth wiper arm defining an elongated plate body and having a first plate member, a second plate member, and step between the first plate member and the second plate member,
the sixth wiper arm defining a U-shaped housing having a pair of side walls, the side walls each defining a first cutout and a second cutout,
the seventh wiper arm including an elongated arm body, an L-shaped leg, and a pin extending laterally from the elongated arm body, the L-shaped leg being shorter than the pin.
